(19) United States
(12) Patent Application Publication
(10) Pub. No.: US 2021/0157558 A1
(43) Pub. Date: May 27, 2021

(54) PROCESS FOR CONSTRUCTING A SIGNATURE CHARACTERISTIC OF THE ACCESSES, BY A MICROPROCESSOR, OF A MEMORY

(71) Applicant: Commissariat a l'Energie Atomique et aux Energies Alternatives, Paris (FR)

(72) Inventors: Riyane SID LAKHDAR, Grenoble Cedex (FR); Henri-Pierre CHARLES, Grenoble Cedex (FR); Maha KOOLI, Grenoble Cedex (FR)

(73) Assignee: Commissariat a l'Energie Atomique et aux Energies Alternatives, Paris (FR)

(21) Appl. No.: 17/091,115

(22) Filed: Nov. 6, 2020

(30) Foreign Application Priority Data
Nov. 27, 2019 (FR) 19 13348

(51) Int. Cl. G06F 8/41; G06F 8/51; G06F 9/30; G06F 9/38

(52) U.S. Cl. CPC G06F 8/453; G06F 8/433; G06F 17/18; G06F 9/30036; G06F 9/3836; G06F 8/51

(57) ABSTRACT

Method for constructing a signature characteristic of the accesses, by a microprocessor, to a memory wherein:
each time the microprocessor executes an access instruction for accessing a datum of a data structure, the microprocessor retrieves the identifier of the data structure and a position identifier that identifies the position of the datum accessed inside this data structure, the temporally ordered series of the position identifiers thus retrieved forming a retrieved access pattern, then
for each retrieved access pattern associated with one and the same data structure identifier, the microprocessor constructs a statistical distribution on the basis of just the position identifiers of this retrieved access pattern, the set of the statistical distributions thus constructed and associated with the identifier of this data structure forming the signature characteristic of the accesses to the memory.

The invention relates to a method for constructing a signature characteristic of the accesses, by a microprocessor, to a memory when this microprocessor executes a computer program. The invention also relates to a method for compiling a source code of a computer program and adapting it specifically for a target computing device with a view to optimization and a method for detecting alteration of an executable code of a computer program executed by a microprocessor, these two methods implementing the method for constructing a characteristic signature.

The invention also relates to an information storage medium for the implementation of these methods and to a compiler.

Hereinafter in this text, the term “computer program” is used as a generic term and may therefore refer both to the source code of this computer program and to the executable code of this computer program.

The expression “accessing a datum” refers to the act of reading and/or of writing a datum in the memory.

The construction of a signature characteristic of the accesses to the memory has numerous different applications. For example, the following article describes an application where such a signature is used to detect malware: Zhixing Xu et Al: “Malware detection using machine learning based analysis of virtual memory access patterns”. Proceedings of the conference on design, automation & test in Europe, pages 169-174. European Design and Automation Association. 2017.

Prior art is also known from WO2019/063930 and JP2010003031, WO2019/063930 aims to recognize a particular function such as matrix multiplication. For this, WO2019/063930 teaches constructing a signature that comprises the series of executed opcodes and, in certain embodiments, a sequence of addresses of data words read or written in the memory during the execution of a function. For this, during the execution of the function, the accessed addresses are systematically retrieved. However, the identifiers of the data structures which comprise the accessed data are not retrieved. Thus, the sequence of retrieved addresses comprise all of the addresses accessed during the execution of the function and not just the accessed addresses corresponding to a particular data structure. Thus, the retrieved sequence of addresses in WO2019/063930 is not representative of a particular traversal of a particular data structure. In addition, this signature is constructed by a handler independent of the computer program executed and in which this particular function must be recognized. Such a handier independent of the executed computer program may only retrieve the physical addresses of the data words read or written by the computer program when it is executed. Such a physical address does not allow the handler to know the position of the datum accessed inside the data structure. Specifically, the physical address retrieved is determined by the operating system. However, operating systems are programmed to optimize the use of the main memory and for this they do not necessarily save all of the data of one and the same data structure next to one another. Thus, the data of one and the same data structure may be scattered in a plurality of ranges of physical addresses separated from one another by other ranges of physical addresses containing data which do not belong to this data structure. Under these conditions, the distance that separates two physical addresses of one and the same data structure is not necessarily representative of the distance that separates the virtual addresses of these same data in the address space of the computer program. In addition, this distance that separates two physical addresses of two data of the same data structure may vary from one execution of the computer program to the next.

JP2010003031 describes a method for analyzing the accesses to a data structure in the object code of a computer program and therefore before compiling and executing this computer program. Thus, this method cannot be implemented with a computer program for which only an executable code is available. In addition, it requires the implementation of a complex analysis of the source code.

The difficulty with the known methods for constructing a signature characteristic of the accesses to the memory is that the characteristic signature constructed by these known methods is poorly reproducible over a large majority of platforms. Specifically, the known characteristic signatures constructed are also dependent on other parameters which have nothing to do with the accesses to the memory. For example, the known characteristic signatures often vary:

according to the hardware architecture of the microprocessor that executes the computer program that accesses the memory,

to the operating system executed by the microprocessor, and

to the number of times when, over the course of the same execution of the executable code, the memory is accessed.

The invention aims to propose a method for constructing a signature characteristic of the accesses to the memory that is more reproducible than the known signatures constructed. One subject thereof is therefore such a method for constructing a characteristic signature as claimed in claim 1.

Another subject of the invention is a method for compiling a source code using the claimed method for constructing a characteristic signature.

Another subject of the invention is a method for detecting an alteration to an executable code using the claimed method for constructing a characteristic signature.

Another subject of the invention is an information recording medium, readable by a microprocessor, this medium comprising instructions for the execution of one of the above methods when these instructions are executed by the microprocessor.

Lastly, another subject of the invention is a compiler for implementing the claimed compiling method.

The invention will be better understood on reading the following description, which is given solely by way of non-limiting example, and with reference to the drawings, in which:

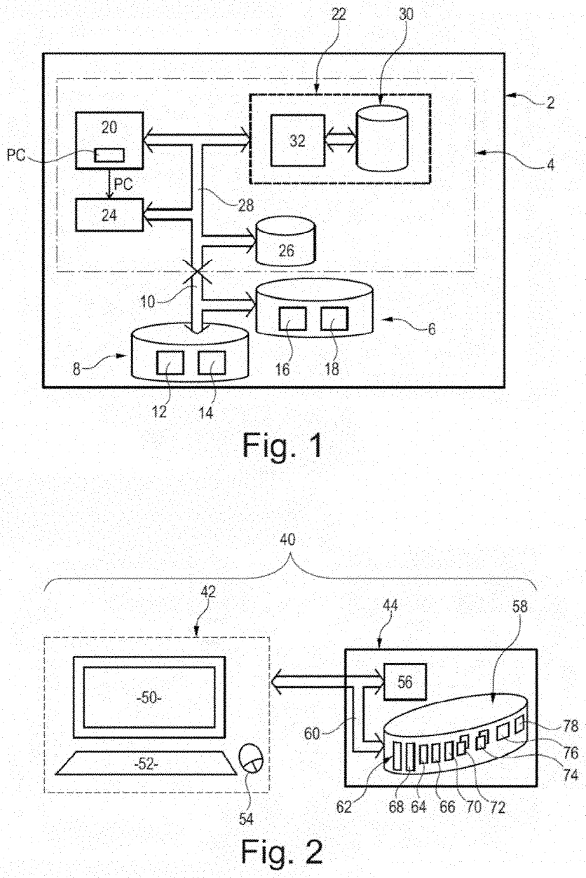

FIG. 1 is a schematic illustration of the architecture of a computing unit incorporating an electronic computing device:

FIG. 2 is a schematic illustration of the architecture of a compiler;

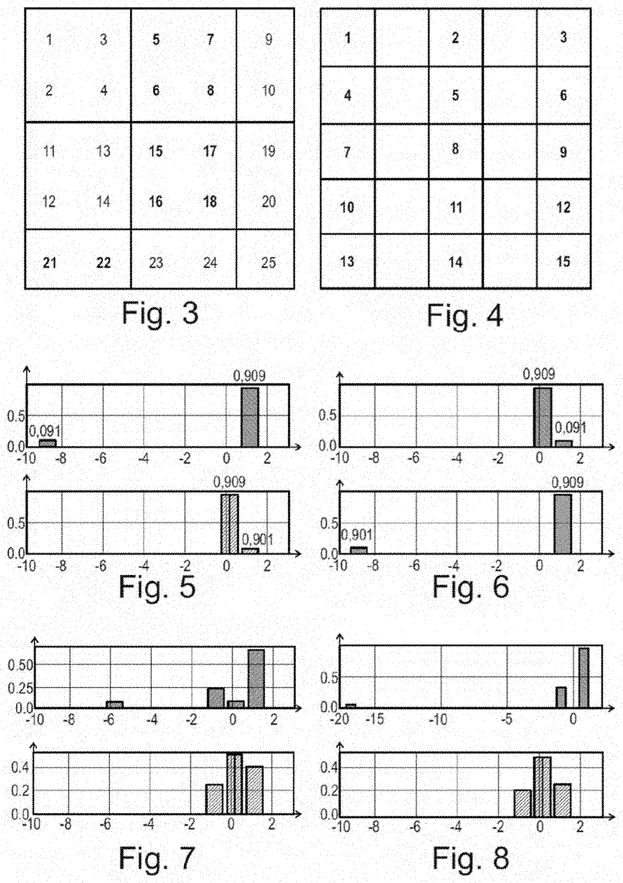

FIGS. 3 and 4 are schematic illustrations of possible traversals of a matrix;

FIGS. 5 to 8 are illustrations of model signatures used by the compiler of FIG. 2;

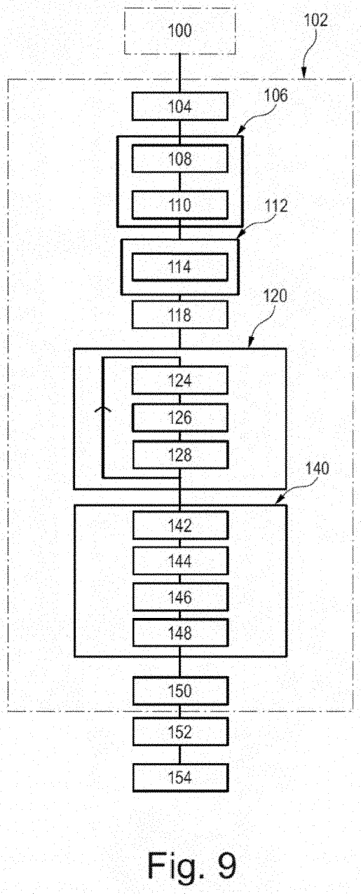

FIG. 9 is a method for compiling a source code implemented by the compiler of FIG. 2;

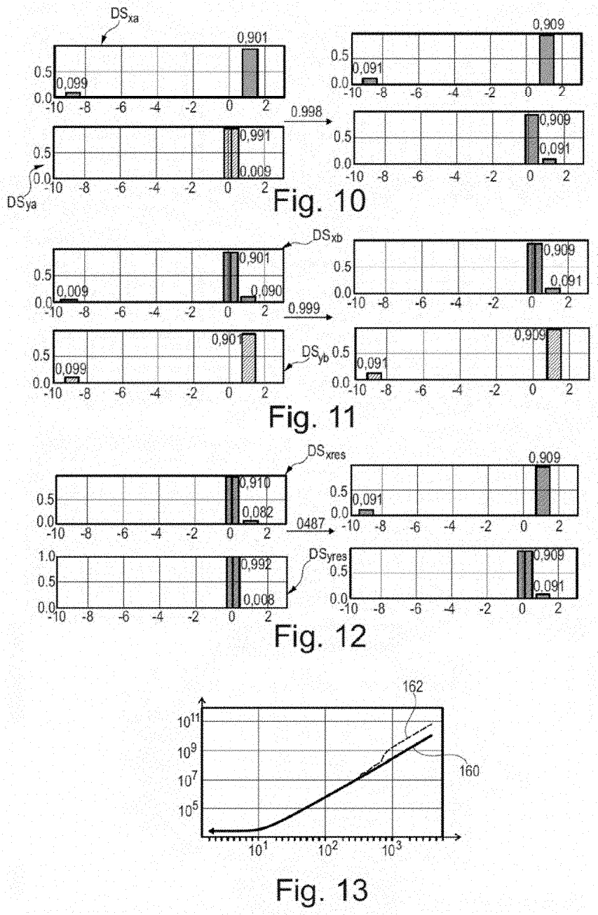

FIGS. 10 to 12 illustrate the comparison of constructed signatures with model signatures in the implementation of the method of FIG. 9;

FIG. 13 is a graph illustrating the improvement to the performance of the executable code generated by the compiler of FIG. 2;

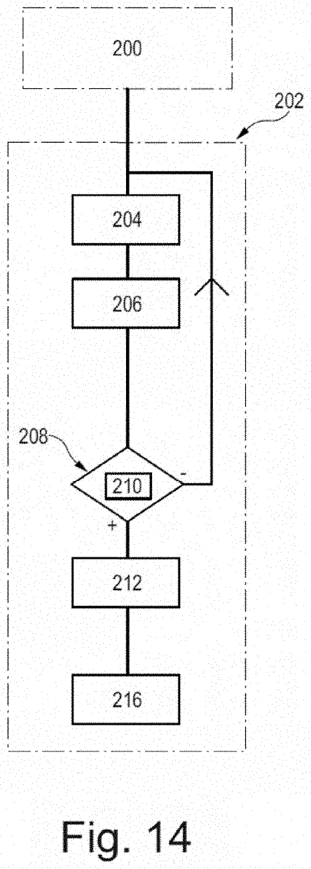

FIG. 14 is a flowchart of a method for detecting an alteration to an executable code.

In these figures, the same references are used to denote elements that are the same. In the remainder of this description, the features and functions that are well known to a person skilled in the art are not described in detail.

In this description, a detailed example of optimized compilation of a source code for a target computing device comprising a cache memory is first described in section I with reference to FIGS. 1 to 13. Next, in the following section II, examples of transposition of the teaching from section I to other target computing devices are presented. In section III, the detection of an alteration to the executable code of a computer program using the same characteristic signature as that presented in section I is described. Different variants of the embodiments described in the preceding sections are described in section IV. Lastly, the advantages of the various embodiments are presented in a final section V.

Section I: Optimized Compilation of Computer Program Source Code

This section describes a compiler and a method for compiling a source code for a target computing device. One example of possible hardware architecture for this target computing device incorporated in a computing unit is first described, then the compiler and the compiling method are described.

FIG. 1 shows an electronic computing unit 2. For example, the unit 2 is a computer, a smartphone, a tablet computer, an engine control unit, inter alia. The hardware structure of such a unit 2 is well known and only the elements required for understanding the invention are shown and described in greater detail. The unit 2 comprises:

a programmable electronic computing device 4,

a main memory 6,

a non-volatile memory 8, and

a bus 10 for transferring data between the memories 6, 8 and the computing device 4.

The computing device 4 is capable of executing an executable code of a computer program obtained after compilation of an original source code of this computer program.

The memory 6 is typically a quick-access memory which the computing device 4 accesses more quickly than the memory 8. Here, the memory 6 is typically a random-access memory. It may be a volatile memory such as a DRAM (“dynamic random-access memory”). The memory 6 may also be a non-volatile random-access memory such as a flash memory.

The memory 8 is for example a hard disk or any other type of non-volatile memory. The memory 8 comprises an executable code 12 of a computer program. The code 12 is suitable for being executed by the computing device 4. The memory 8 may also comprise data 14 to be processed by this program when it is executed. During the execution of the executable code 12 by the computing device 4, the instructions of the code 12 and the data 14 are first transferred into the memory 6 for quicker access thereto. In the memory 6, the instructions of the executable code 12 and the data 14 processed by this program bear, respectively, the numerical references 16 and 18.

When it is executed, the executable code 12 processes structured data. A structured datum is a data structure. A data structure is a structure that groups together a plurality of data within a continuous range of virtual addresses. Within this range of addresses, the data are placed in relation to one another according to a predetermined arrangement. Under these conditions, the position of a datum inside a data structure is identified by one or more indices. Thus, on the basis of the knowledge of a base address of the data structure and of the values of the indices that identify the position of a datum inside this data structure, it is possible to construct the virtual address of this datum in the memory space of the computer program. Using this virtual address, each datum of the data structure may directly be accessed individually. Thus, this datum may be read or written independently of the other data of the data structure. The base address of a data structure is for example the virtual address with which this data structure begins or ends.

There is a large number of possible data structures like a matrix with one or more dimensions or an object in object-oriented programming, inter alia. Given that one of the most frequently used data structures is a two-dimensional matrix, the main detailed embodiment examples are given in the particular case where the data structure is a two-dimensional matrix. However, the teaching provided in this particular case is transposed without difficulty to other data structures.

In the case of a matrix, the position of each datum inside the matrix is identified using indices. Conventionally, in the case of a two-dimensional matrix, these indices are called “row number” and “column number”. The processing of such data structures by the executable code 12 involves numerous accesses to the data of this data structure.

The computing device 4 comprises:

a microprocessor 20 also known by the acronym CPU (“central processing unit”).

a cache memory 22,

a preloading module 24 also known as a “prefetcher”,

a buffer 26, and

a bus 28 for transferring data between the microprocessor 20, the memory 22, the module 24, the buffer 26 and the bus 10.

The microprocessor 20 is capable of executing the executable code 12. To this end, it further comprises a register PC called a program counter or instruction pointer which contains the address of the instruction currently being executed or of the next instruction to be executed by the microprocessor 20.

The cache memory 22 is here a cache memory with one or more levels. In this example, the cache memory 22 is a cache memory with three levels. In this case, the three levels are known as, respectively, level L1, level L2 and level L3. The cache memory 22 allows data to be stored which the microprocessor 20 can access more quickly than if they had been only stored in the memory 6.

For level L1, the memory 22 comprises a memory 30 and a micro-computing device 32. The memory 30 contains the data which the microprocessor 20 can access more quickly without having to read them in the memory 6. The micro-computing device 32 handles the saving and the deletion of data in the memory 30. In particular, when a new datum has to be saved in the memory 30, the micro-computing device 32 determines, according to an algorithm specific thereto, the one or more data to be deleted from the memory 30 in order to free the space required to save this new datum in the cache memory 22.

The architecture of the other levels L2 and L3 is similar and has not been shown in FIG. 1.

The module 24 has the function of predicting, before the microprocessor 20 has need thereof, the location where the data to be preloaded into the cache memory 22 then of triggering the preloading of these data. To this end, the module 24 may comprise a micro-computing device dedicated to this function. In this case, it comprises its own memory containing the instructions required to execute a preloading method and its own microprocessor which executes these instructions. It may also be a dedicated integrated circuit. In this case, the instructions of the preloading method are hardwired into this integrated circuit.

The memory 26 is here a buffer used by the module 24 for temporarily saving the one or more data to be preloaded there before they are transferred, if necessary, into the cache memory 22.

In the case of the computing device 4, transferring a complete word or a complete row from the memory 6 into the buffer 26 does not take any more time than transferring just the datum to be preloaded. In addition, transferring a complete word or a complete row also allows the occurrence of cache errors to be limited. Thus, in the case of the target computing device 4, it is preferable for the data of a data structure loaded into the memory 22 to be accessed in the same order as the order in which they are saved in the cache memory 22. Specifically, this limits cache errors and this therefore considerably accelerates the execution of the executable code 12.

At this juncture, it is pointed out that the arrangement of the data structure that allows the execution of the executable code to be accelerated depends notably on the computer program executed and on the hardware architecture of the target computing device.

In this text, what is meant by “arrangement of a data structure”, is the arrangement of the data of this data structure in the memory. In particular, this therefore means:

the arrangement of the different data of the data structure in relation to one another, and

the location where the data structure is saved in the one or more memories of the target computing device.

The computer program determines the temporal order in which the data of the data structure are accessed. Thus, an arrangement of a data structure optimized for one particular computer program is not necessarily optimal for another computer program. For example, an arrangement in memory of a matrix optimized for a first computer program which accesses this matrix row by row is not optimized for a second computer program which accesses this same matrix column by column. What is meant here by “optimized arrangement” is an arrangement of the data of the data structure in the memory that improves a predefined performance of the target computing device. This predefined performance is a physical quantity measurable using an electronic sensor. In this embodiment, the predefined performance is the speed of execution of the computer program. The speed of execution is measured by counting the number of clock cycles of the microprocessor between the time when the execution of the program begins and the time when this execution ends.

FIG. 2 shows a compiler 40 capable of generating an executable code of a computer program in which the arrangements of the data structures are automatically optimized to increase its speed of execution by the computing device 4. More specifically, the compiler 40 improves the speed of execution by generating an optimized executable code which, when it is executed by the target computing device, uses, whenever possible, optimized arrangements of the data structures in memory. Thus, the compiler 40 improves the performance of the target computing device not by modifying the order in which the instructions for accessing the data are executed, but merely by optimizing the arrangement of the data structures in the memory. Thus, the compiler 40 in no way modifies the algorithm developed by the developer who wrote the source code.

To this end, the compiler 40 comprises:

a human-machine interface 42, and

a central unit 44.

The human-machine interface 42 comprises, for example, a screen 50, a keyboard 52 and a mouse 54 which are connected to the central unit 44.

The central unit 44 comprises a microprocessor 56 and a memory 58, and a bus 60 for exchanging information connecting the various elements of the compiler 40 to one another.

The microprocessor 56 is capable of executing the instructions saved in the memory 58. The memory 58 comprises:

an original source code 62 of the computer program to be compiled,

the instructions of a non-optimized compiling module 64,

the instructions of an optimized compiling module 66,

the instructions of a module 68 for retrieving access patterns,

the instructions of a module 70 for constructing signatures characteristic of accessing the memory,

a database 72 of the transformation functions, and

a database 74 of the optimal codings of each data structure.

The source code 62 is a source code which, after compilation, corresponds to an executable code which processes and manipulates data structures when it is executed by the target computing device. To this end, the source code 62 contains notably:

declarations of one or more data structures,

instructions for accessing the data of the declared data structures, and

instructions for manipulating the accessed data.

The instructions for manipulating the data are, for example, chosen from the group consisting:

of Boolean instructions, such as the operators OR, XOR, AND, NAND, and

of arithmetic instructions such as addition, subtraction, division or multiplication.

Hereinafter, the description of the compiler 40 is illustrated in the particular case where the source code 62 performs the multiplication of two matrices “a” and “b” and saves the result of this multiplication in a matrix “res”. One example of such a source code is given in annex 1 at the end of the description. In these annexes, the numbers on the left and in small characters are numbers of rows.

Here, the source code 62 is written in a programming language called hereinafter “V0 language”. The V0 language is identical to the C++ language except that it has additionally been provided with the instruction “MATRIX_DEFINE”, “MATRIX_ALLOCATE”, “MATRIX_FREE”.

The instruction “MATRIX_DEFINE” declares a data structure and, more precisely, a two-dimensional matrix. The instruction “MATRIX_ALLOCATE” dynamically allocates, generally in the heap, the memory space where the data structure declared using the instruction “MATRIX_DEFINE” is saved and returns a pointer which points to the start of this data structure. The instruction “MATRIX_FREE” frees the memory space previously allocated by the instruction “MATRIX_ALLOCATE”. These instructions “MATRIX_DEFINE”, “MATRIX_ALLOCATE”, “MATRIX_FREE” also perform additional functions described in greater detail below.

Thus, in the listing of annex 1, the instruction “MATRIX_DEFINE (TYPE a)” declares a matrix “a”, in which each cell contains a datum having the type “TYPE”. In the source code 62, the type “TYPE” is equal to the type “int” of the C++ language. Thus, each cell of the matrix “a” contains an integer.

The instruction “MATRIX_ALLOCATE(TYPE, N0, N1, a)” allocates a memory space large enough to save the matrix “a” of N0 columns and N1 rows there and in which each cell contains a datum of the type “TYPE”.

The instruction “MATRIX_FREE(a, N0, N1, TYPE)” frees the memory space previously allocated to save the matrix “a” there. Thus, after the execution of this instruction, data other than those of the matrix “a” may be saved in this freed memory space.

In addition, the V0 language contains specific instructions for accessing the data of a data structure. In the particular case of the source code 62, since the data structures of the source code 62 are matrices, these specific instructions are denoted “MATRIX_GET”, “MATRIX_SET” and “MATRIX_ADD”.

The instruction “MATRIX_GET(a, k, j)” returns the datum stored in the cell of the matrix “a” located at the intersection of the row “j” and of the column “k”. It is therefore a function for reading a datum in a matrix.

The instruction “MATRIX_SET(res, i, j, d)” saves the value “d” in the cell of the matrix “res” located at the intersection of the row “j” and of the column “k”. It is therefore an instruction for writing a datum in a matrix.

The instruction “MATRIX_ADD(res, i, j, tmp_a*tmp_b)” adds the result of the scalar multiplication of the numbers tmp_a by the number tmp_b to the datum contained in the cell of the matrix “res” located at the intersection of the row “j” and of the column “i”. Once this instruction has been executed, the datum previously contained in the cell of the matrix “res” located at the intersection of the row “j” and of the column “i” is replaced with the result of this addition. This instruction “MATRIX_ADD” is therefore also an instruction for writing a datum in a matrix.

The compiling module 64 automatically generates, on the basis of a source code of a computer program, written in V0 language, a non-optimized executable code 76. The executable code 76 is executable by the compiler 40. To this end, it uses the set of instructions of the machine language of the microprocessor 56. When compiling the source code, the module 64 implements, for each data structure declared in the source code, a predefined standard arrangement of this data structure in the memory 58. Thus, when the executable code 76 is executed by the microprocessor 56, each data structure is saved in the memory using the same standard arrangement.

For example, in the case where the data structures are matrices, the standard arrangement of each matrix in the memory 58 is a row arrangement, better known as a “row layout”. The row arrangement is an arrangement in which the rows of the matrix are saved one after the other in the memory. To do this, each time the module 64 encounters a specific instruction “MATRIX_ALLOCATE”, it replaces it with a set of instructions corresponding to the C++ language which codes this row arrangement. Hereinafter, this corresponding set of instructions is called the “standard set of instructions” since it codes the standard arrangement of the data structure.

One example of such a standard set of instructions in C++ language which codes the row arrangement of the matrix “a” is shown in lines 13 to 15 of the listing of annex 2. Another example of a standard set of instructions for the matrix “res” can be seen in lines 21 to 23 of the listing of annex 2.

The module 64 also replaces each of the other specific instructions of the source code 62 with a corresponding set of instructions in C++ language which codes the corresponding function. For example, here, as illustrated by the listing of annex 2:

the specific instruction “MATRIX_DEFINE(TYPE, a)” is replaced with the instruction “Int**a” in C++ language,

the instruction “MATRIX_SET(res, i, j, 0)” is replaced with the instruction “res[j][i]=0” in C++ language,

the specific instruction “MATRIX_GET(a, k, j)” is replaced with the instruction “a[j][k]” in C++ language, and

the instruction “MATRIX_ADD(res, i, j, tmp_a*tmp_b)” is replaced with the instruction “res[j][i]+=tmp_a*tmp_b” in C++ language.

After having replaced, in the source code 62, each of the specific instructions with the corresponding standard set of instructions, the module 64 obtains an intermediate source code written entirely in C++ language. The module 64 is capable of compiling, for example in the conventional manner, this intermediate source code to obtain the executable code 76.

Here, the specific instructions that access a datum of a data structure are additionally associated with a set of instructions allowing the retrieving module 68 to be implemented. When replacing each specific instruction that accesses a datum of a data structure with the corresponding set of instructions in C++ language, the module 64 also adds, into the intermediate source code, a set of instrumentation instructions associated with this specific access instruction. Typically, the set of instrumentation instructions is added into the intermediate source code immediately before or after the set of instructions corresponding to this specific access instruction. The set of instrumentation instructions is described in greater detail further on.

The module 66 generates automatically, on the basis of the source code of the computer program written in V0 language, an executable code 78 optimized for a given target computing device. The executable code 78 is executable by the target computing device. To this end, it uses the set of instructions of the machine language of the microprocessor of the target computing device. The executable code 78 is therefore not necessarily executable by the compiler 40 when the set of instructions of the machine language of the target computing device is different from that of the microprocessor 56.

In addition, at least for some of the data structures declared in the source code, the module 66 uses an optimized arrangement different from the standard arrangement. Thus, when the target computing device executes the executable code 78, it saves, in its memory, at least one of the data structures according to an optimized arrangement different from the standard arrangement chosen by default by the compiling module 64.

However, in this embodiment, the compiling module 66 does not modify the order, defined by the source code, in which the access instructions are executed. In other words, when the processed data are identical, the order in which the access instructions are executed by the target computing device when it executes the executable code 78 is the same as the order in which these access instructions are executed by the compiler 40 when it executes the executable code 76.

For example, for this, the module 66 replaces each specific instruction of the source code 62 with the corresponding set of instructions in C++ language. In this regard, the module 66 operates in a similar way to that described in the case of the compiling module 64. However, when it encounters a specific instruction “MATRIX_ALLOCATE” and when there is an optimized arrangement for the data structure to be saved in the memory space allocated by this specific instruction, it replaces it automatically with an optimized set of instructions instead of replacing it with the standard set of instructions. The optimized set of instructions is a corresponding set of instructions in C++ language which codes the optimized arrangement of the data structure.

One example of an optimized set of instructions is shown in lines 17 to 19 of the listing of annex 2. In these lines, the optimized arrangement implemented by the optimized set of instructions is an arrangement in which the matrix “b” is saved in the memory in the form of a series of columns. This arrangement of a matrix is known as a column arrangement and more commonly as a “column layout”.

Thus, the module 66 automatically transforms the source code 62 into an optimized source code written entirely in C++ language. Next, the module 66 compiles this source code optimized for the target computing device. This compiling is, for example, performed in the conventional manner.

The retrieving module 68 is capable of retrieving, during the execution of the executable code 76 by the compiler 40, and for at least one data structure declared in the source code, the access pattern for accessing this data structure.

An access pattern is a temporally ordered series of position identifiers of the data accessed one after the other during the execution of the executable code 76 by the microprocessor 56. Here, the position identifier of a datum is chosen from the group consisting:

of the indices that allow the position of the datum inside the data structure to be identified, and

of the virtual address of the accessed datum.

The position identifier is therefore here either an index or a virtual address.

The indices that allow the position of the datum inside the data structure to be identified are generally used to construct the virtual address of this datum on the basis of a base address of the data structure and of the values of these indices. The base address of the data structure is typically the virtual address at which the memory space in which this data structure is stored begins. Here, each data structure is located within a single continuous range of virtual addresses. In other words, inside this range, there are no data which do not belong to this data structure. In the case of a two-dimensional matrix, the indices correspond to the row and column numbers at the intersection of which the datum to be accessed is located. In this embodiment example, the position identifiers used are the row and column numbers of the datum accessed in the matrix.

It is pointed out here that the retrieving module 68 retrieves the access pattern for accessing a data structure. Thus, if the source code comprises a plurality of data structures for which the access patterns have to be retrieved, the module 68 retrieves at least one access pattern for each of these data structures. The access pattern for accessing a particular data structure comprises only the position identifiers of the data accessed inside this data structure. To differentiate the different access patterns that the module 68 retrieves, each retrieved access pattern is associated with the identifier of the data structure for which this access pattern has been retrieved.

In this embodiment, the module 68 is implemented by instrumenting the executable code 76. For this, for example, each specific instruction of the V0 language which is an access instruction for accessing a datum of a data structure is associated with a set of instrumentation instructions. The set of instrumentation instructions is written in C++ language. It allows, when it is executed by the microprocessor 56, the access pattern for accessing a data structure to be retrieved.

To this end, here, the instructions “MATRIX_SET”, “MATRIX_GET”, “MATRIX_ADD” are, each, associated with a set of instrumentation instructions which, when it is executed by the microprocessor 56:

retrieves the identifier of the accessed data structure and the position identifier of the datum accessed inside this data structure, then

adds this retrieved position identifier to the rest of the position identifiers already retrieved for this same data structure in order to complete the retrieved access pattern for this data structure.

In the case of a two-dimensional matrix, the execution of this set of instrumentation instructions retrieves the identifier of the accessed matrix and the row and column numbers of the datum accessed inside this matrix. Next, these retrieved row and column numbers are added, respectively, to first and to second access patterns. The retrieved first and second access patterns contain only the row and column numbers, respectively, of the accessed data.

In addition, in this embodiment, the module 68 retrieves the size of each data structure for which an access pattern is retrieved. To this end, the specific instruction which allocates the memory space in which the data structure has to be saved is also associated with a set of instrumentation instructions, in C++ language. In the case of the specific instruction for allocating memory space, the set of instrumentation instructions allows, when it is executed, the size of the data structure to be retrieved and for it to be associated with the identifier of this data structure. Here, this specific instruction is the instruction “MATRIX_ALLOCATE”. The instruction “MATRIX_ALLOCATE” is parameterized by the number of rows and the number of columns of the matrix. When the set of instrumentation instructions associated with the specific instruction “MATRIX_ALLOCATE” is executed by the microprocessor 56:

the microprocessor 56 retrieves the number of rows and the number of columns of the matrix, and

associates this retrieved row and column number with the identifier of this matrix.

Like for the other sets of instrumentation instructions, this set of instrumentation instructions is automatically added into the intermediate source code, generated by the module 64, immediately before or after the set of instructions in C++ language corresponding to the encountered specific instruction “MATRIX_ALLOCATE”. Thus, the executable code 76 is here also instrumented to retrieve the size of each data structure for which an access pattern has to be retrieved.

The module 70 is capable of constructing, on the basis of a retrieved access pattern for a data structure, a signature characteristic of the accesses to this data structure. Here, the module 70 is capable of constructing a characteristic signature:

which is independent of the number of accesses to the data structure over the course of the same execution of the executable code 76, and

which does not, or practically does not, vary from one execution of the executable code 76 to the next.

To this end, the module 70 transforms the retrieved access pattern into a transformed access pattern. The transformed access pattern allows a characteristic suitable for identifying the traversal of the data structure to be made apparent. In this embodiment, the transformed access pattern is identical to the retrieved access pattern, except that each retrieved position identifier is replaced with a relative position identifier. The relative position identifier of a datum identifies the position of this datum in relation to another datum of the same data structure. For this, the module 70 applies, to each retrieved position identifier, a transformation function denoted f_{t,m} which transforms this retrieved position identifier into a relative position identifier. In this embodiment, the function f_{t,m}:

calculates a first term according to the retrieved position identifier to be replaced,

calculates a second term according to another retrieved position identifier belonging to the same retrieved access pattern, then

calculates the relative position identifier on the basis of the difference between these first and second terms.

The first term is independent of the position identifier used to calculate the second term. Reciprocally, the second term is independent of the position identifier to be replaced, used to calculate the first term.

There is a very large number of possible functions f_{t,m}. The function f_{t,m} allows a characteristic signature capable of revealing a particular traversal of the data structure to be obtained. A traversal of a data structure is the temporal order in which the data of the data structure are accessed, one after the other, during the execution of the computer program. A particular traversal is a traversal of a data structure that is associated with an optimized arrangement of the data structure by the database 74.

Depending on the hardware architecture of the target computing device, the optimized arrangement of the data structure that makes it possible to improve the speed of execution for a particular traversal is not necessarily the same. In particular, an optimized arrangement may exist only for certain hardware architectures. Thus, here, the function f_{t,m} is also chosen according to the hardware architecture of the target computing device.

To this end, the module 70 is capable of automatically selecting, from the database 72, a function f_{t,m} corresponding to the acquired identifier of the hardware architecture of the target computing device. By way of illustration, in this first section, only a transformation function, denoted f_{t,1} that is usable in the case where the architecture of the target computing device is that described with reference to FIG. 1 is presented. Other examples of function f_{t,m} for other hardware architectures of target computing devices are described in section II.

In the case of the computing device 4, to accelerate the execution of a computer program, it is preferable for the data of the data structure to be saved in the same order as the order in which the microprocessor 20 accesses these data. Specifically, as described above, the cache memory 22 is loaded with entire blocks of contiguous data. Thus, if a datum D₁ to be accessed is loaded with an adjacent datum D₂ and if the computer program accesses the datum D₂ immediately after the datum D₁, this does not cause any cache error and the execution of the computer program is quick. Conversely, if after having accessed the datum D₁, the microprocessor systematically accesses a datum D₃ of the same data structure located in the memory 6, at a position far from the datum D₁, this causes a cache error and therefore slows down the execution of the computer program. In the case where the data structure is a matrix, this means, for example, that if the computer program accesses the data of this matrix row by row, then the optimized arrangement of the matrix in memory is the row arrangement. Conversely, if the computer program accesses the data of the matrix column by column, then the optimized arrangement of this matrix in memory is the column arrangement. Here, the function f_{t,1} is therefore chosen such that the obtained transformed access pattern allows a characteristic signature to be constructed that is representative of the temporal order in which the data of the matrix are accessed. To this end, the function f_{t,1} is here defined by the following relationships: f_{t,1}(xₜ)=(xₜ−xₜ₋₁) and f_{t,1}(yₜ)=(yₜ−yₜ₋₁), where:

f_{t,1}(xₜ) and f_{t,1}(yₜ) are the relative position identifiers, respectively, of the row and of the column of the accessed datum,

xₜ and yₜ are the row and column numbers, respectively, of the datum accessed at time t, and
xₜ₋₁ and yₜ₋₁ are the row and column numbers, respectively, of the preceding datum accessed in the same matrix at time t−1.

In the retrieved access pattern, the indices xₜ₋₁ and yₜ₋₁ are the indices that immediately precede the indices xₜ and yₜ.

The module 70 is also capable of constructing, for each transformed access pattern, its normalized statistical distribution. A statistical distribution comprises classes of possible values and, associated with each of these classes, a number linked, typically by a bijective function, to the number of occurrences of this class in the transformed access pattern. Here, the normalized statistical distribution is the normalized statistical distribution of the relative position identifiers contained in the transformed access pattern. Here, each normalized statistical distribution comprises predefined classes. Each predefined class corresponds to one or more possible values of the relative position identifier. There are enough classes to cover all of the possible values of the relative position identifier. Here, each class corresponds to a single possible value of the relative position identifier.

With each class, the statistical distribution associates a quantity that is dependent on the number of times that the value of the relative position identifier corresponding to this class appears in the transformed access pattern. Here, the statistical distribution is “normalized”, i.e. the sum of the quantities associated with each of the classes of the statistical distribution is equal to one. To this end, the quantity associated with a class is obtained:

by counting the number of occurrences of this class in the transformed access pattern, then

by dividing this number of occurrences of the value corresponding to this class in the transformed access pattern by the total number of relative position identifiers contained in this transformed access pattern.

The combination of the different statistical distributions constructed for the same data structure forms the signature characteristic of the accesses to this data structure.

The database 72 associates each function f_{t,m} with one or more possible target computing device hardware architectures. Thus, when the compiler 40 has acquired the identifier of the hardware architecture of the target computing device for which the source code has to be compiled, the module 70 is capable of automatically selecting, from the database 72, the function f_{t,m} to be used to construct the characteristic signature.

The hardware architecture identifier identifies in particular the hardware architecture of the memories of the target computing device. In this embodiment, the hardware architecture of the memories refers notably to their hardware structure but also to their mode of operation. For example, the hardware architecture of the computing device 4 is identified by the identifier Id_{cc4}. A target computing device that differs from the computing device 4 only in its preloading module 24 is identified by an identifier that is different from the identifier Id_{cc4}. Specifically, the preloading module 24 is a key element in the handling of the cache memory 22 and an optimized arrangement for the computing device 4 might not be optimal for an identical target computing device unless it uses another strategy for preloading the data in the cache memory 22.

The database 74 allows one or more model signatures associated with a given function f_{t,m} to be extracted. Thus, in this embodiment, the function f_{t,m} is also used as a key for associating the saved data of tables 72 and 74 with one another. In particular, it is by way of this function f_{t,m} that an identifier of hardware architecture of the target computing device is associated with one or more signature models. A model signature is structurally identical to a signature constructed by the module 70. More precisely, a model signature is identical to the signature that is constructed by the module 70 when it uses this given function f_{t,m} and when the microprocessor traverses the data of the data structure by following a particular traversal. For one and the same data structure, the number of possible different particular traversals increases according to the number of data contained in this data structure. The number of possible different particular traversals for one and the same data structure is therefore generally very large. Hereinafter, to simplify the description, only a few examples of particular traversals are described in detail. However, the teaching provided in the particular case of these few examples may be applied and transposed to any other possible particular traversal. For example, in the case where the data structure is a matrix, the particular traversals for which it is possible to extract a model signature from the database 74 are here:

A traversal P1, i.e. a row-by-row traversal in which the rows of the matrix are accessed one after the other.

A traversal P2, i.e. a column-by-column traversal in which the columns of the matrix are accessed one after the other.

A traversal P3, i.e. a traversal of the main diagonal (or “diagonal major”), in which only the main diagonal of the matrix is accessed.

A traversal P4, i.e. a traversal per row of two-by-two blocks, then per column inside each of these blocks.

A traversal P5, i.e. a column-by-column traversal skipping every column whose column number is even.

Examples of traversals P4 and P5 are illustrated, respectively, in FIGS. 3 and 4. In these figures, each number is located within a cell of the matrix. Each number indicates the order number of the order in which this cell is accessed. Thus, the cells of these matrices are accessed in the order 1, 2, 3, 4 . . . etc. When a cell of the matrix does not comprise an order number, this means that the datum contained in this cell is not accessed in the particular traversal of this matrix. This is notably the case of the particular traversal shown in FIG. 4.

Generally, for one and the same particular traversal of a data structure, the model signature varies according to the size of the data structure. Here, to avoid saving, in the database 74, for each particular traversal, as many model signatures as there are possible sizes for the data structure, the database 74 associates a parameterized signature model with each function f_{t,m}.

Here, the parameter of the signature model is the size of the data structure for which a model signature has to be extracted. The parameterized signature model is here implemented in the form of a code that is executable by the microprocessor 56. This parameterized signature model generates, when it is executed for a particular value of the parameter, the model signature corresponding to this particular traversal of a data structure of this size.

Annexes 3 to 6 give the listings, in PYTHON language, of the signature models corresponding to the particular traversals, respectively, P1, P2, P3 and P4. FIGS. 5 to 8 show the model signatures generated, after normalization, by, respectively:

the signature model of annex 3 for a matrix of ten rows and of ten columns,

the signature model of annex 4 for a matrix of ten rows and of ten columns,

the signature model of annex 6 for a matrix of seven rows and of fourteen columns, and

the signature model of annex 6 for a matrix of twenty rows and of twenty columns.

In this embodiment, for a matrix, a first transformed access pattern is obtained on the basis of the retrieved row numbers and a second transformed access pattern is obtained on the basis of the retrieved column numbers. Thus, in this particular embodiment, the signature characteristic of the accesses to this matrix comprises first and second normalized statistical distributions constructed on the basis, respectively, of the first and second transformed access patterns. Similarly, each model signature therefore comprises first and second statistical distributions. Each of FIGS. 5 to 8 shows, at the top, the first statistical distribution and, at the bottom, the second statistical distribution. In each of FIGS. 5 to 8, the abscissa axis shows the different possible values of the relative position identifier and the ordinate axis shows the quantity associated with each value of the abscissa axis. The numbers given beside certain bars of the statistical distributions shown correspond to the height of this bar.

As shown by FIGS. 7 and 8, for one and the same particular traversal, the model signature varies according to the size of the matrix.

In the listings of annexes 3 to 6, the following notations are used:

“dimX” is the number of rows of the matrix;

“dimY” is the number of columns of the matrix;

“deltaX” is a table that contains the classes associated with a non-zero quantity in the statistical distribution;

“deltaY” is a table that contains the non-zero quantities associated with a class of the statistical distribution;

“nbBlock_Y_ceil” is equal to the block number in a column of the matrix.

The PYTHON language is a language well known to a person skilled in the art and is well documented. Consequently, a person skilled in the art is capable of understanding and of implementing the different signature models given in annexes 3 to 6 without further explanation. In addition, to simplify these listings, the normalization operation of normalizing each of the statistical distributions of the model signature has not been shown. This normalization operation typically consists in dividing each number of occurrences of each statistical distribution by the total number of data accessed in the particular traversal of the matrix.

The signature models shown in annexes 3 to 6 have been established by comparing, for one and the same particular traversal, different signatures constructed using the function f_{t,1}, for different sizes of the matrix. This comparison makes it possible to identify the one or more quantities of the statistical distribution that vary according to the size of the matrix. For example, in the case of traversal P1, which varies according to the size of the matrix, it is the relative position identifier calculated at the moment of moving on to the next row. It may easily be seen that at this particular moment, for the index xₜ, the relative position identifier f_{t,1}(xₜ) is equal to 1−dimX. The number of occurrences of row jumps is, for its part, equal to dimY−1.

It may also be seen that outside of these particular moments, the index x, is only incremented by 1 at each time t. In this case, the calculated relative position identifier f_{t,1}(xₜ) is equal to 1 and the number of occurrences of the value “1” in the transformed access pattern is equal to dimY*(dimX−1).

In the case of more complex traversals, like traversal P4, the signature model may be constructed by breaking this more complex traversal down in the form of a composition of a plurality of simple particular traversals. For example, traversal P4 may be broken down into:

a row-by-row traversal of the blocks, and

a column-by-column traversal within each block.

The signature model of traversal P4 is therefore established by putting the signature models of traversal P1 together with the signature model of traversal P2. Generating model signatures by combining a plurality of signature models with one another makes it possible, for one and the same number of model signatures capable of being generated, to substantially decrease the number of signature models and therefore to decrease the size of the database 74.

Annexes 3 to 6 are parameterized signature models established for a few examples of particular traversals. However, by applying the same methodology, it is possible to construct a parameterized signature model for any other particular traversal. The methodology described here also makes it possible to establish signature models for all types of data structures and is not limited to the case of matrices.

The database 74 also associates an optimized arrangement of the data structure with each signature model. The scientific literature discloses, for a large number of different particular traversals, the optimized arrangement of the data structure that allows the execution of the computer program by the target computing device to be accelerated. The database 74 associates, with each signature model established for a particular traversal, the optimized arrangement corresponding to this particular traversal. Preferably, the database 74 therefore comprises a plurality of, and preferably more than five or ten, signature models, each associated with a respective optimized arrangement. Here, to simplify the description and because the optimized arrangements are known, only three examples of optimized arrangements are described in greater detail. The implementation of an optimized arrangement described in the particular case of these examples may be transposed without difficulty, by a person skilled in the art, to any other known optimized arrangement. For examples of other known optimized arrangements that can be associated with other signature models which may be incorporated into the database 74, the reader may consult the following articles:
Ilya Issenin et al. “Multiprocessor system-on-chip data reuse analysis for exploring customized memory hierarchies”, 2006, 43rd ACM/IEEE Design Automation Conference. IEEE, p 49-52;
Doosan Cho et al: “Compiler driven data layout optimization for regular/irregular array access patterns”, ACM Sigplan Notices, Vol. 43. ACM. 41-50, 2008.

In this embodiment, each optimized arrangement takes the form of a conversion table which, with each specific instruction of the V0 language, associates a generic set of instructions on the basis of which the modules 64 and 66 may generate the corresponding set of instructions in C++ language.

This set is said to be “generic” because it contains parameters that are replaced by values or names of variables of the source code 62 when the intermediate source code is generated by the modules 64 and 66.

Three examples of conversion tables are given in annexes 7 to 9.

The conversion table of annex 7 contains, in the first column, the specific instruction in V0 language and, in the second column, the generic set of instructions associated therewith. The generic set of instructions is that used by the modules 64 and 66 to generate the corresponding set of instructions in C++ language. Each specific instruction contained in the source code 62 contains, for each of the parameters of the generic set associated therewith, a value or the name of a variable. When the modules 64 and 66 replace the specific instruction in V0 language with the corresponding set of instructions in C++ language, they replace the parameters of the generic set of instructions, associated with this specific instruction by this conversion table, with the values or the names of variables contained in the specific instruction of the source code 62.

Thus, it may be seen that the generic set of instructions associated by the table of annex 7 with the specific instruction “MATRIX_ALLOCATE” is identical to that shown in lines 13 to 15 of the listing of annex 2, except that the type of the data of the matrix, the number of rows of the matrix, the number of columns of the matrix and the name of the matrix are replaced with the parameters, respectively “TYPE”, “NDL”, “NDC” “NAME”. Thus, the optimized arrangement of annex 7 is an arrangement in which the matrix is saved in the memory in the form of a series of rows.

Annex 8 shows the conversion table corresponding to the optimized arrangement associated, by the database 74, with the function f_{t,1} and with the signature model of annex 4. This table is identical to the table of annex 7, except that the generic set of instructions associated with the specific instruction “MATRIX_ALLOCATE” saves the matrix in the memory in the form of a series of columns and not in the form of a series of rows.

Annex 9 shows the conversion table corresponding to the optimized arrangement associated, by the database 74, with the function f_{t,1} and with the signature model of traversal P3.

The operation of the compiler 40 will now be described with reference to the method of FIG. 9.

Initially, in a design phase 100, a developer writes, in V0 language, the source code 62 of the computer program. This code is written without specifying the arrangement of the data structures in memory. Thus, the writing of this source code is conventional, except that for at least one of the data structures of this source code, the developer uses the specific instructions of the V0 language instead of using conventional instructions of the C++ language. For example, in the case of the source code 62 of annex 1, each creation of a matrix and each access to the data of the matrices are coded using the specific instructions of the V0 language.

Once the source code 62 has been written, a phase 102 of the source code 62 being compiled by the compiler 40 begins. This phase 102 begins with a step 104 of providing the source code 62 and of providing the databases 72 and 74. On completion of this step, the source code 62 and the databases 72 and 74 are saved in the memory 58 of the compiler 40.

Next, in a step 106, the compiling module 64 generates the executable code 76 on the basis of the source code 62.

For this, in an operation 108, the module 64 transforms the source code 62 into an instrumented intermediate source code, only written in C++ language. This transformation consists here in replacing each specific instruction of the V0 language of the source code 62 with the concatenation of the corresponding set of instructions in C++ language and of the set of instrumentation instructions associated with this specific instruction. By default, in this first compilation of the source code 62, for each data structure of the source code 62, it is the standard set of instructions which is used. To do this, the module 64 therefore systematically uses the conversion table of annex 7. Consequently, in this embodiment, each data structure is saved in the memory, during the execution of the executable code, using the standard arrangement.

On completion of operation 108, the instrumented intermediate source code is only written in C++ language and comprises, for each data structure, the instructions that make it possible to retrieve the identifier of this data structure and the position identifiers of the data accessed inside this data structure.

In an operation 110, the intermediate source code obtained on completion of operation 108 is compiled to generate the executable code 76.

In a step 112, the microprocessor 56 of the compiler 40 executes the executable code 76.

During this execution, the microprocessor 56 dynamically allocates, for each data structure, a memory space to save the data of this data structure there. Next, the microprocessor accesses the data of the data structure in the order defined in the source code 62 and therefore according to a traversal coded by the developer of the source code 62. Lastly, the microprocessor frees the dynamically allocated memory space when the data structure is no longer used.

In response to the dynamic allocation of a memory space to save a data structure there, a pointer to the start of this memory space is generated. This pointer is typically equal to a virtual address called here a “virtual base address” at which this memory space begins. Here, this pointer constitutes the identifier of the data structure or is associated with the identifier of the data structure.

In each access to a datum of the data structure, the microprocessor 56 starts by constructing the virtual address of this datum on the basis of the base address and of the values of the indices that identify the position of this datum inside the data structure.

Next, it executes the access instruction for accessing this datum. This access instruction may be an instruction for writing or for reading the datum. This access instruction contains an operand from which the virtual address of the accessed datum is obtained. These instructions correspond here to the instructions coded in lines 29 and 32 to 34 of the listing of annex 1.

Between two accesses to the data of the data structure, the microprocessor executes an instruction that modifies the one or more indices such that in the execution of the next access instruction, it is the next datum of the data structure which is accessed. In the listing of annex 1, this corresponds to the incrementation of the indices j, i and k that can be seen in lines 25, 27 and 30, respectively, of this listing.

During this execution of the executable code 76, the microprocessor 56 also executes the instructions corresponding to the sets of instrumentation instructions introduced into the intermediate source code by the compiling module 64. Thus, in step 112, the module 68 for retrieving the access patterns is also executed by the microprocessor 56 at the same time as the executable code 76.

Then, in an operation 114, each time the microprocessor 56 accesses a datum of a data structure, the module 68 retrieves:

the identifier of this data structure, and

the position identifiers of the datum accessed inside this data structure.

In this embodiment, the identifiers of the position of the datum correspond, respectively, to the number of the row xₜ and to the number of the column yₜ at the intersection of which the accessed datum is located. In the listing of annex 1, this therefore corresponds to the values of two of the indices chosen from among the indices i, j and k which are used, in the source code, to denote the row and column numbers.

Next, the module 68 adds, to the access pattern constructed specifically for this data structure, the retrieved values of the indices. Thus, for example, each time the matrix “a” of the source code 62 is accessed, the module 68 retrieves the values of the indices x_{a,t}, y_{a,t} of the datum accessed in this matrix. Here, the indices x_{a,t} and y_{a,t} correspond, respectively, to the values of the variables k and j of line 32 of the listing of annex 1. Next, the module 68 adds, to an access pattern MA specifically associated with the matrix “a” and containing the preceding values retrieved for the index x_{a,t}, the new retrieved value. Thus, the access pattern MAₓₐ takes the form of a series {x_{a,1}; x_{a,2}; . . . ; x_{a,t}} of row numbers classed in the order of the times at which these numbers were retrieved.

In parallel, the module 68 adds, to a second access pattern MA_{ya} specifically associated with the matrix “a” and containing the preceding values retrieved for the index y_{a,t}, the new retrieved value. Thus, this access pattern MA_{ya} takes the form of a series {y_{a,1}; y_{a,2}; . . . ; y_{a,t}} of column numbers classed in the order of the times at which these numbers were retrieved.

In addition, in this embodiment, each time a memory space is dynamically allocated to save a data structure there, the module 68 retrieves the size of this memory space. Here, in the case where the data structures are two-dimensional matrices, the module 68 retrieves the number of rows dimX and the number of columns dimY and associates them with the identifier of this matrix. This information is for example saved in the memory 58.

Once the execution of the executable code 76 is finished, in a step 118, the compiler 40 acquires an identifier of the hardware architecture of the target computing device for which the source code 62 has to be compiled. Here, this identifier is acquired by way of the human-machine interface 42. For the remainder of this description, it is assumed that the hardware architecture identifier acquired in step 118 is the identifier Id_{cc4} of the hardware architecture of the computing device 4 of FIG. 1. It is therefore an identifier of a hardware architecture with three levels of cache memory and a preloading module 24 which loads entire blocks of contiguous data into the cache memory 22.

Next, in a step 120 and after the end of the execution of the code 76, the module 70 constructs, for each data structure, the signature characteristic of the accesses to this data structure.

For this, in an operation 124, the module 70 selects the function f_{t,m} associated, by the database 72, with the identifier of the hardware architecture acquired in step 118. Here, it is the function f_{t,1}.

In an operation 126, the module 70 then transforms each of the access patterns retrieved for a data structure into a transformed access pattern by applying the selected function f_{t,1}. Thus, in the case of the matrix “a”, the access patterns MAₓₐ and MA_{ya} are transformed into transformed access patterns MATₓₐ and MAT_{ya}, respectively.

The access pattern MATₓₐ is equal to the series of relative position identifiers {f_{t,1}(x₂); f_{t,1}(x₃); . . . ; f_{t,1}(x_{a,n})}, i.e. equal to the series {x_{a,2}−x_{a,1}; x_{a,3}−x_{a,2}; . . . ; x_{a,n}−x_{a,n-1}}, where n is equal to the total number of elements of the access pattern MAₓₐ. Similarly, the pattern MAT_{ya} is equal to the series {f_{t,1}(y_{a,2}); f_{t,1}(y_{a,3}); . . . ; f_{t,1}(y_{a,n})}, i.e. equal to the series {y_{a,2}−x_{a,1}; x_{a,3}−x_{a,2}; . . . ; x_{a,n}−x_{a,n-1}}.

Next, in an operation 128, the module 70 constructs the normalized statistical distributions DSₓₐ and DS_{ya} of the values, respectively, of the access patterns MATₓₐ and MAT_{ya}.

The construction of the statistical distribution is conventional. The normalization of the constructed statistical distribution consists here in dividing the number of occurrences of each class in the transformed access pattern by the number n−1 of elements of this transformed access pattern.

The combination of the statistical distributions DSₓₐ and DS_{ya} constitutes the characteristic signature constructed for the accesses to the matrix “a” during the execution of the executable code 76 by the microprocessor 56.

Operations 124 to 128 are reiterated for each of the data structures for which the module 68 has retrieved access patterns in step 112.

Once the characteristic signature has been constructed for each of the accessed data structures, the compiler 40 moves on to a step 140 of automatically optimizing the computer program for the target computing device. For this, for each data structure, it proceeds as follows.

In an operation 142, the compiling module 66 extracts, from the database 74, the different model signatures that may correspond to the signature constructed for this data structure. Here, to this end, it selects, from the database 74, the signature models associated with the function f_{t,1} used to construct the signature. In doing this, the module 66 therefore selects signature models that are associated with the same hardware architecture as that of the computing device 4.

Then, using each selected signature model and by replacing, in this signature model, the variables dimX and dimY with the values retrieved in operation 114, the compiler 40 constructs the model signature of a particular traversal of the data within a matrix of the same size.

When the selected signature model comprises a variable whose value is not known, then the compiling module 66 executes this signature model for each of the possible values of this variable. Thus, in this case, on the basis of one and the same signature model and for the same size of the data structure, a plurality of model signatures are generated. This is for example the case when the signature model of annex 6 is selected. Specifically, this signature model comprises the variable “nbBlock_Y_ceil” whose value is not retrieved by the module 68. The possible values of the variable “nbBlock_Y_ceil” are the integers between 1 and dimY.

In an operation 144, the compiling module 66 compares the constructed signature with each model signature extracted from the database 74 in operation 142.

Here, to make this comparison between the constructed signature and the model signature, the module 66 calculates a coefficient of correlation between each statistical distribution of the constructed signature and the corresponding statistical distribution of the model signature. In this embodiment, this coefficient of correlation is an adaptation of the coefficient known as the “Pearson coefficient”. This coefficient is defined by the following relationship (1):

$$ρ ( {DS}_{c} , {DS}_{m} ) = \frac{1}{N} \frac{{\sum }_{i = 0}^{N - 1} ( {DS}_{c} [ i ] - {E}_{DSc} ) ( {DS}_{m} [ i ] - {E}_{DSm} )}{{σ}_{s} {σ}_{{s}^{′}}}$$

where:

ρ(DS_{c}, DSₘ) is the coefficient of correlation,

DS_{c} and DSₘ are, respectively, the compared constructed statistical distribution and model statistical distribution,

N is the total number of classes of the compared statistical distribution,

DS_{c}[i] is the quantity associated with the i^{th} class by the statistical distribution DS_{c},

DSₘ[i] is the quantity associated with the i^{th} class by the statistical distribution DSₘ,

E_{DSc} and E_{DSm} are the expected values, respectively, of the statistical distributions DS_{c} and DSₘ.

σ_{DSc} and σ_{DSm} are the standard deviations, respectively, of the statistical distributions DS_{c} and DSₘ.

Next, the coefficient of correlation between the constructed signature and a model signature is taken to be equal to the average of the coefficients of correlation that are calculated for each of the statistical distributions of the constructed signature.

FIG. 10 shows, on the left, the two statistical distributions DSₓₐ and DS_{ya} constructed for the matrix “a” in step 120 in the case where the size of the matrix “a” is ten rows and ten columns.

FIG. 10 shows, on the right, the two statistical distributions of the model signature extracted from the database 74 that have the highest coefficient of correlation with the constructed signature. In this case, it is the model signature generated by the signature model of annex 3, i.e. that corresponding to traversal P1. FIG. 10 also shows, on the left, the two statistical distributions of the characteristic signature constructed for the matrix “a” when it comprises ten rows and ten columns. The numerical value above the arrow that points from the constructed signature to the model signature is the value of the calculated coefficient of correlation between the constructed signature and the model signature.

FIGS. 11 and 12 are identical to FIG. 10 except that the matrix “a” is replaced with, respectively, the matrices “b” and “res” of the source code 62. In this case, the matrices “b” and “res” are matrices of ten rows and ten columns.

FIG. 11 shows that the signature characteristic of the accesses to the matrix “b” exhibits a very high correlation with the model signature generated on the basis of the signature model of annex 4, i.e. that corresponding to the particular traversal P2 of a matrix.

FIG. 12 shows that the model signature that is the most highly correlated with the signature constructed for the matrix “res” is again that generated on the basis of the signature model of annex 3.

At the end of operation 144, for each data structure, the module 66 identifies the model signature that corresponds best to the characteristic signature constructed for this data structure. For this, the module 66 retains the model signature that exhibits the highest coefficient of correlation with the signature constructed for this data structure. Hereinafter, the model signature thus identified is referred to as the model signature “corresponding to the constructed characteristic signature”.

In an operation 146, for each data structure, the module 66 automatically selects the optimized arrangement that is associated, by the database 74, with the signature model used to generate the model signature corresponding to this data structure. Thus, in view of the results illustrated in FIGS. 10 to 12, the module 66 selects the optimized arrangement of annex 7 for the matrices “a” and “res” and the optimized arrangement of annex 8 for the matrix “b”.

Next, in an operation 148, the module 66 replaces each specific instruction that manipulates a particular data structure in the source code 62 with a corresponding set of instructions in C++ language. The corresponding set of instructions is generated on the basis of the generic set of instructions associated with this specific instruction by the conversion table selected for this data structure in operation 146. More precisely, the corresponding set of instructions in C++ language is obtained by replacing the different parameters of the generic set of instructions with the values of the parameters of the specific instruction.

For example, the specific instruction “MATRIX_ALLOCATE (TYPE, N0, N1, a)” of line 13 of the source code 62 comprises the following values “TYPE”, “N0”, “N1” and “a” of the parameters “TYPE”, “NBL”, “NBC”, “NAME” of the generic set of instructions associated with this specific instruction by the conversion table of annex 7. Then, after replacing the parameters of the generic set of instructions with these values, the module 66 obtains the corresponding set of instructions in C++ language shown in lines 13 to 15 of listing 2. By doing likewise for the specific instruction of line 17 of the source code 62 and this time using the conversion table of annex 8, the module 66 obtains a corresponding set of instructions in C++ language shown in lines 17 to 19 of the listing of annex 2.

Thus, at the end of operation 148, the module 66 obtains an intermediate source code in which the arrangement of the data structures is optimized. In the case of the source code 62, the source code thus obtained is that of annex 2.

Next, in a step 150, the module 66 compiles the intermediate source code obtained on completion of step 140 for the target computing device 4. This step is, for example, performed in the conventional manner. On completion of step 150, the optimized executable code 78 has been generated.

In a step 152, the executable code 78 is loaded into the memory 8 of the computing unit 2 and becomes the executable code 12, executed by the computing device 4.

In a step 154, the computing device 4 executes the executable code 12 generated by the compiler 40.

Different tests have been carried out to verify that the executable code 78 generated by the compiler 40 does indeed allow the performance of the computing device 4 to be improved when it executes this executable code 78.

FIG. 13 shows the change, according to the size of the matrices “a”, and “b”, in the time required to perform the multiplication of these matrices when the computing device 4 executes the executable code 78 (line 160) and when the computing device 4 executes a conventional executable code (line 162). The conventional executable code is obtained by compiling a source code, identical to the source code 62, using a conventional C++ compiler. For these tests, the matrices “a”, “b” and “res” are square matrices of the same size and the abscissa axis gives only the number of rows of the matrix “a”. In FIG. 13, the time taken to execute the multiplication is measured by counting the number of clock cycles of the microprocessor 20.

FIG. 13 shows that for matrices of relatively large size, i.e. here having more than a thousand rows, the computing device 4 performs the same calculation ten times more quickly when it executes the executable code 78 than when it executes the conventional executable code.

Other tests with other source codes implementing other computer processes that manipulate matrices have been carried out. In the majority of these cases, the executable code generated by the compiler 40 turned out to be quicker than an executable code generated by a conventional compiler. More precisely, in the majority of cases, the executable code generated by the compiler 40 is executed four to fifty times more quickly than the same executable code but generated conventionally. It has also been observed that in the worst case, the executable code generated by the compiler 40 is executed at the same speed as the executable code generated conventionally.

Still for testing the compiler 40, the source code 62 was modified by adding instructions that generate random accesses to the matrices “a”, “b” and “res”. For example, in each random access, the values of the row and column numbers of the accessed datum are drawn randomly or pseudo-randomly. Thus, the random accesses cannot correspond to a particular traversal of the data structure and, on the contrary, add noise into the constructed characteristic signature. In the tests carried out, the rate of random accesses to each matrix was gradually increased from 0% to 50%. The rate of random accesses to a matrix is the ratio of the number of random accesses to the total number of accesses to this matrix over the course of an execution of the computer program. These tests have shown that for a rate of random accesses lower than or equal to 20%, the module 66 still manages, for each matrix “a” and “b” and “res”, to select the correct optimized arrangement. Thus, the compiler 40 remains advantageous even if the signatures constructed for the accesses to the matrices “a”, “b” and “res” are noisy.

Section II: Other Examples of Hardware Architecture

So far, the embodiment of the compiler 40 has been illustrated in the particular case where the hardware architecture of the target computing device is that described with reference to FIG. 1. However, what has been described above may be adapted for any type of hardware architecture. In particular, there are electronic computing devices where to obtain an executable code quicker, optimized arrangements other than those described above have to be implemented. For this, each time, the compiler 40 has to be adapted to handle this hardware architecture. The adaptations made to adapt the compiler 40 for other target computing device hardware architectures are obtained according to the following methodology:

1) Identifying, for example by consulting the literature specific to this hardware architecture, at least one arrangement of a data structure that improves the speed of execution of the target computing device when it accesses the data of this structure by following a particular traversal.
2) Establishing a function f_{t,m} so as to obtain a transformed access pattern that makes it possible to construct a characteristic signature suitable for identifying the existence and, alternately, the absence of this particular traversal identified in point 1) above. Here, it is considered that the constructed signature is suitable for characterizing the existence and, alternately, the absence of the particular traversal if the constructed signature, when the data are accessed according to the particular traversal, is different from the constructed signature in the absence of this particular traversal.
3) Constructing a signature model that generates the model signature which has to be extracted from the database 74. The model signature is identical to the characteristic signature constructed when the executed computer program traverses the data structure according to the particular traversal identified in point 1). This signature model is associated with the function f_{t,m} established in point 2) above by the database 74.
4) Constructing the optimized arrangement, i.e. a conversion table such as the tables of annexes 7 to 9, and associating it with the corresponding signature model in the database 74.

### EXAMPLE 1: IN-MEMORY COMPUTING SYSTEM

For example, other potential target computing devices comprise in-memory computing systems such as that described in the following article: Maha Kooli et AL: “Smart instruction codes for in-memory computing architectures compatible with standard sram interfaces” 2018 Design, Automation & Test in Europe Conference & Exhibition (DATE), pages 1634-1639. IEEE, 2018. In this case, the optimized arrangement of the data structure may consist in saving the data of this data structure in this in-memory computing system rather than in another memory such as another cache memory.

The methodology described in a generic manner above is now illustrated in the particular case of the hardware architecture of this target computing device which comprises an in-memory computing system.

An in-memory computing system is a memory that is capable of performing certain operations between the data that are saved there. For example, such a memory is referred to by the expression “C-SRAM”. For the C-SRAM memory to be able to execute an operation between two data, it is necessary for these two data to be aligned in relation to one another. In other words, the bits of these two data have to be aligned in columns. If this is not the case, before triggering the execution of the operation, at least one of the data has to be moved in the memory so as to align it with the other datum. Such an operation of moving a datum takes time and therefore slows down the execution of the executable code.

In the case of such a hardware architecture, it is advantageous to save the data in the C-SRAM memory if they are correctly aligned in relation to one another. Specifically, in this case, the operation between two of the data saved in this memory may be executed more quickly by the C-SRAM memory than if this same operation were performed conventionally by the microprocessor. However, if the data are not correctly aligned in relation to one another, it would be better for the operation to be executed by the microprocessor.

To adapt the compiler 40 to hardware architectures comprising an in-memory computing system, the identifier of this hardware architecture is associated, by the database 72, with a transformation function f_{t,2}. The function f_{t,2} is for example the following: f_{t,2}(@_{v,i})=f_{c}(@_{v,i})−f_{c}(@_{v,i-1}), where:

@_{v,i} and @_{v,i-1} are the virtual addresses of the data of the data structure that are accessed to perform an operation “v” between two of these data,

f_{c}(@_{v,i}) is the following operation: f_{c}(@_{v,i})=@ mod L, where:
L is the length, in number of bits, of each row of the C-SRAM memory,
“mod” denotes the modulo operation, thus, the term @_{v,i} mod L is equal to the remainder of the Euclidean division of the address @_{v,i} by the length L.

The operation “v” is an operation that may be executed by the C-SRAM memory. Thus, the addresses @_{v,i} and @_{v,i-1} are the virtual addresses of the operands of this instruction “v”.

The term @_{v,i} mod L is representative of the distance that separates the datum corresponding to this address @_{v,i} from the start of the row of the C-SRAM memory. The difference between the terms f_{c}(@_{v,i}) and f_{c}(@_{v,i-1}) is therefore representative of the alignment of one of these data in relation to the other. Consequently, the number of shifts to be executed to align these two data is proportional to this difference.

In this case, the model signature is for example a normalized statistical distribution that associates, with the zero value of the relative position identifier, the quantity 1. This model signature is associated by the database 74 with an optimized arrangement that comprises a generic set of instructions which, when it is executed, saves the operands of the instruction V in the C-SRAM memory and causes the execution of the operation “v” by the C-SRAM memory.

For this, for example, the instruction “v” is coded in the source code by a specific instruction in V0 language. This specific instruction allows the generation, in step 106, of an executable code 76:

which causes the execution of the operation “v” by the microprocessor 76,

which retrieves the virtual addresses @_{v,i} and @_{v,i-1} each time this instruction “v” is executed, and

which associates the retrieved virtual addresses @_{v,i} and @_{v,i-1} with the identifier of the data structure accessed to form the retrieved access pattern.

Next, in operation 148, the specific instruction which allocates a memory space to save the data structure there is replaced with the optimized set of instructions. In this case, the optimized set of instructions, when it is executed by the target computing device:

saves the data structure in the C-SRAM memory, and

causes the execution of the operation “v” by the C-SRAM memory.

Thus, if the identifier of the hardware architecture acquired by the compiler 40 in step 118 corresponds to a hardware architecture comprising a C-SRAM memory with rows of length L, then the compiler 40 is capable of generating an executable code 78 specially optimized for this hardware architecture.

### EXAMPLE 2: SECONDARY MEMORY

Other potential target computing devices comprise what is referred to here as a “secondary memory”. A secondary memory is a memory that is physically distinct from the main memory. In addition, this secondary memory corresponds, in the address space of the computer program, to a range of addresses that is distinct from the range of addresses corresponding to the main memory. Thus, the secondary memory is used during the execution of the computer program only if the executable code of this computer program comprises:

instructions that handle the transfer of data between the main memory and the secondary memory, and

access instructions for accessing the secondary memory.

The access instructions for accessing the secondary memory comprise, as an operand, a virtual address within the range of addresses of the address space of the computer program which corresponds specifically to the secondary memory. In this, a secondary memory is different from cache memories and other similar memories handled automatically by the operating system and/or a micro-computing device specifically dedicated to this function. Specifically, to benefit from the presence of such cache memories, the executed computer program does not need to comprise instructions that handle the transfer of data between the main memory and the cache memories and to comprise access instructions for accessing the cache memories. In addition, unlike a secondary memory, a cache memory does not correspond to a range of addresses, in the address space of the computer program, that is different from the range of addresses of the main memory.

Thus, to use a secondary memory, the developer has to manually introduce, into the source code of the computer program:

instructions for transferring data between the main memory and the secondary memory, and

access instructions for accessing the secondary memory.

One example of such a secondary memory is a memory known by the acronym SPM (“scratchpad memory”). The accesses to such a secondary memory are quicker than the accesses to the main memory and to the cache memory.

In the case of a target computing device comprising a secondary memory, the optimized arrangement of the data structure consists in saving at least a portion of the data of this data structure in this secondary memory rather than in another memory of the target computing device.

To adapt the compiler 40 to hardware architectures comprising a secondary memory, the identifier of this hardware architecture is associated, by the database 72, with a transformation function f_{t,3}. Here, the function f_{t,3} calculates, for each datum D_{S,n} of the data structure S, a value f_{t,3}(D_{S,n}) representative of the advantage of saving this datum D_{S,n} in the secondary memory.

The larger the value f_{t,3}(D_{S,n}), the greater the expected gain in speed of execution of the computer program by placing the datum D_{S,n} in the secondary memory. For this, in this embodiment, the value f_{t,3}(D_{S,n}) increases according to a quantity Av(D_{S,n}) and decreases according to a quantity Occ(D_{S,n}). The quantities Av(D_{S,n}) and Occ(D_{S,n}) are described in greater detail below. They are calculated on the basis of the access pattern retrieved for the data structure S.

For this, here, the module 70 starts by combining the two access patterns retrieved for each index of the data structure S so as to form just one complete access pattern comprising, for each accessed datum, its complete position identifier. For example, in the case of the matrix “a”, the module 70 combines the access patterns MAₓₐ and MA_{ya} to obtain the complete access pattern {(x_{a,1}, y_{a,1}); (x_{a,2}, y_{a,2}); . . . ; (x_{a,t-1}, y_{a,t-1}); (x_{a,t}, y_{a,t}); . . . ; (x_{a,max}, y_{a,max})}, where (x_{a,t}, y_{a,t}) is the identifier of the position of the datum of the matrix “a” accessed at time t.

Next, to calculate the quantity Occ(D_{S,n}), the module 70 counts the number of times that the position identifier, corresponding to the datum D_{S,n} occurs in the retrieved complete access pattern. This number is equal to the value of the quantity Occ(D_{S,n}), i.e. to the number of times that the datum D_{S,n} has been accessed during the execution of the code 76.

The module 70 also counts in the retrieved complete access pattern, between each pair “id” of consecutive position identifiers of the datum D_{S,n} the number Na_{id} of position identifiers that are different from that corresponding to the datum D_{S,n}. This number Na_{id} is therefore equal to the number of data, other than the datum D_{S,n}, accessed between two consecutive accesses to the datum D_{S,n}. The total of these numbers Na_{id} divided by the number of intervals between the identifiers of the position of the datum D_{S,n} gives the value of the physical quantity Av(D_{S,n}). This number of intervals between two data D_{S,n} accessed consecutively is equal to Occ(D_{S,n})−1.

Here, the value f_{t,3}(D_{S,n}) is defined by the following relationship: f_{t,3}(D_{S,n})=Av(D_{S,n})/Occ(D_{S,n}). When the quantity Occ(D_{S,n}) is zero or equal to one, the value f_{t,3}(D_{S,n}) is equal to zero.

Preferably, to accelerate the calculation of the value f_{t,3}(D_{S,n}), it is calculated using the following relationship:

$$C ( {D}_{i} ) = \frac{1}{{\sum }_{j = 0}^{n - 1} {s}_{i} ( j )} \times \frac{\text{?} \text{?} Dirac ( {\sum }_{j = 0}^{N - 1} {s}_{i} ( \text{?} ) - j )}{{\sum }_{j = 0}^{N - 1} {s}_{i} ( j ) - 1}$$

$$\text{?} \text{indicates text missing or illegible when filed}$$

where:

Dᵢ is the datum located at the address @ᵢ in the data structure S,

C(Dᵢ) is equal to the value f_{t,S}(Dᵢ),

the symbol “x” denotes the multiplication operation,

Occ(i) is the number of accesses to the address @ᵢ and therefore to the datum Dᵢ,

N is the total number of accesses to the data structure S.

sᵢ( ) is a similarity function such that sᵢ(j)=1 if the i-th address accessed is the same as the j-th address accessed in the retrieved access pattern,

Dirac( ) is the discrete Dirac function.

More precisely, the similarity function sᵢ( ) is defined by the following relationship:

$$∀ i ∈ [ 0 , N - 1 ] , {s}_{i} : \{ \begin{matrix}[ [ 0 , N - 1 ] ] \to \{ 0 , 1 \} \\ j \to \{ \begin{matrix}1 if {@}_{i} = {@}_{j} \\ 0 otherwise\end{matrix} \}\end{matrix} \}$$

where:

@ᵢ and @ⱼ are, respectively, the i-th address and the j-th address accessed,

The function Dirac( ) is defined by the following relationship:

where the terms “if” and “otherwise” have the same meaning as in the preceding relationship.

According to a first embodiment, the statistical distribution constructed on the basis of the transformed access pattern contains classes for each value or range of possible values for the different values f_{t,3}(Dᵢ) contained in the transformed access pattern. This statistical distribution forms the signature characteristic of the accesses to the data structure S.

According to a second, preferred embodiment, the statistical distribution associates the value f_{t,3}(Dᵢ) with each address @ᵢ of a datum Dᵢ of the data structure. Specifically, the value f_{t,3}(Dᵢ) is already a function of the number of occurrences of the datum Dᵢ in the retrieved access pattern.

When the function f_{t,3} is used, the transformed access pattern contains not relative position identifiers but rather values representative of the advantage of saving a particular datum in the secondary memory. In this case, the model signature is associated by the database 74 with an optimized arrangement that comprises a generic set of instructions which, when it is executed, saves certain data of the data structure that are associated with the highest values f_{t,3}(Dᵢ) in the secondary memory.

### OTHER EXAMPLES

The compiler 40 may also be adapted for multiprocessor hardware architectures in which the data structure may equally be saved in a local memory of a microprocessor or in a memory common to a plurality of microprocessors. In this case, a known optimized arrangement consists in saving the data structure in the common memory when different processors have to access this data structure concomitantly and, in the opposite case, in saving this data structure in the local memory of one of the microprocessors.

Section III: Other Applications of the Module 70 for Constructing a Characteristic Signature

The characteristic signature constructed by the module 70 is more reproducible than the known characteristic signatures. Notably, it does not vary according to the quantity of accessed data. It does not vary either according to a modification to the range of virtual addresses in which the data structure is saved. These advantages may be put to good use in applications other than the optimization of executable code.

For example, by way of illustration, a method for detecting an alteration to an executable code is proposed here. Such alterations qualified as “malicious” are for example introduced by malicious programs known as “malware” or “Viruses”. Thus, this method makes it possible to detect the presence of such malicious programs.

In this example, the computing unit that executes the executable code is for example identical to the computing unit 2 except that:

the executable code 12 is replaced with the executable code of a specific computer program, and

the memory 8 additionally comprises instructions for implementing this method for detecting an alteration to the executable code 12.

Thus, in particular, the memory 8 comprises the instructions of the module 70 for constructing a characteristic signature.

The method for detecting an alteration to the executable code is now described with reference to the method of FIG. 14.

The method begins with an initializing phase 200. In this phase 200, the original executable code of the specific computer program is provided. The original executable code is a version of the executable code that is certain to be free of malicious alterations. In this embodiment example, this original executable code incorporates the instructions of the module 68 for retrieving access patterns for each data structure for which a characteristic signature has to be constructed.

A database BdRef from which may be extracted, for each data structure, model signatures of the accesses to this data structure is also provided. Here, the model signature of the accesses to a data structure is an expected and predictable signature of the accesses to this data structure corresponding to that which may be observed when the original executable code is executed.

This database BdRef is typically established by executing the original executable code. During this execution, the module 68 retrieves, for each data structure:

the identifier of the data structure,

the size of this data structure,

a time t_{ref} at which the accessing of this data structure begins, and

the access patterns for accessing this data structure.

For example, the time t_{ref} is a number of clock cycles of the microprocessor counted from the start of the execution of the executable code.

Next, for each data structure, the module 70 constructs the signature characteristic of the accesses to this data structure. In the context of detecting an alteration to the executable code, the possible choices for the transformation function f_{t,m} are generally more numerous. Specifically, it is sufficient for the chosen function f_{t,m} to make it possible to construct a signature that varies according to the traversal, by the microprocessor, of the data of this data structure. By way of illustration, here, the function f_{t,m} is chosen so as to be equal to the function f_{t,1}.

In one possible embodiment, each constructed characteristic signature is then compared with model signatures extracted from the database 74. Here, the database 74 is, for example, identical to that described in section I. It is for example produced by implementing operations 142 and 144 of the method of FIG. 9.

Next, the association between the identifier of the data structure and the signature model that makes it possible to generate the model signature that is the most highly correlated with the constructed signature is saved in the database BdRef. The value V_{cor-inf} of the coefficient of correlation between the constructed signature and this model signature is saved in the database BdRef associated with the identifier of this data structure. Similarly, the retrieved time t_{ref} is saved in the database BdRef associated with the identifier of this data structure.

The database BdRef may be established by executing the original executable code on any computing unit equipped with the module 70 for constructing a characteristic signature and with the database 74.

Once phase 200 has ended, a phase 202 of using the executable code begins. In this use phase, the executable code is executed. Each time the executable code is executed, the following steps are carried out.

In a step 204, the module 68 retrieves, for each accessed data structure:

the identifier of this data structure,

the size of this data structure,

a time tₜ at which the accessing of this data structure begins, and

one or more access patterns.

Next, in a step 206, the module 70 constructs, for each data structure, a characteristic signature. This step 206 is for example identical to step 120 described above.

In a step 208, the microprocessor compares the characteristic signature constructed for this data structure with the model signature extracted from the signature model associated with the same data structure identifier by the database BdRef. In step 208, the microprocessor calculates a coefficient of correlation V_{cor,t} between the constructed characteristic signature and the extracted model signature. For example, this coefficient of correlation V_{cor,t} is calculated as described above in the case of operation 144.

Next, in an operation 210, the microprocessor compares the value V_{cor,t} with the value V_{cor-inf} associated, by the database BdRef, with the same data structure identifier.

If the deviation between the values V_{cor,t} and V_{cor-inf} exceeds a predetermined threshold, in a step 212, the microprocessor triggers the signaling of a malicious alteration to the executable code. Specifically, an alteration to the executable code often manifests as a modification to the access patterns for accessing one or more data structures.

In addition, here, for each data structure, operation 210 additionally comprises the comparison of the retrieved time tₜ with the time f_{ref} extracted from the database BdRef. If the deviation between these two times exceeds a predetermined threshold, the method goes to step 212. Thus, in this embodiment, the method is also suitable for detecting an alteration to the flow of execution of the executable code.

In the opposite case, the triggering of the signaling of a malicious alteration is inhibited. Step 208 is executed for each data structure for which the module 68 has retrieved its identifier, its size and an access pattern.

In a step 216, in response to the signaling of a malicious alteration to the executable code, the microprocessor executes a countermeasure. There is a large number of different possible countermeasures that may be implemented. For example, the executed countermeasure is chosen from the group consisting of:

displaying a message indicating that a malicious alteration to the executable code has been detected,

the interruption of the execution of the executable code, and

the deletion and destruction of the executable code.

The microprocessor may also execute a combination of a plurality of the countermeasures from the group above.

Section IV: Variants

Section IV.1: Common Variants

What has been described in the particular case where the data structure is a two-dimensional matrix applies, after adaptation, to any type of data structure. In the case where the data structure is not a two-dimensional matrix, the specific instructions “MATRIX_DEFINE”, “MATRIX_ALLOCATE”, “MATRIX_GET”, “MATRIX_SET”, “MATRIX_FREE” of the V0 language are replaced, respectively, with specific instructions “D_DEFINE”, “D_ALLOCATE”. “D_GET”, “D_SET”, “D_FREE”. These specific instructions starting with “D_” each perform the same function as that described in the particular case where the data structure is a two-dimensional matrix. However, the corresponding set of instructions in C++ language has to be adapted. For example, if the data structure is a one-dimensional matrix, the corresponding set of instructions in C++ language has the specific instruction “D_DEFINE n” and “int*n”. Similarly, if the data structure is a three-dimensional matrix, the corresponding set of instructions in C++ language has the specific instruction “D_DEFINE” and the instruction “int***n”.

The set of instrumentation instructions also has to be adapted. For example, in the case where the data structure is a matrix with one or with more than three dimensions, the number of indices to be retrieved in each access to a datum of this data structure is not the same.

Other embodiments of the language V0 are possible. For example, instead of using the C++ programming language for the instructions other than the specific instructions, other programming languages may be used such as the C, Ada, Caml or PASCAL language for these other instructions.

Section IV.2—Variants of the Construction of the Characteristic Signature

The transformation function f_{t,m} may be executed immediately each time a position identifier is retrieved and only the result of the transformation function is saved directly in the transformed access pattern. This variant thus makes it possible to avoid saving the complete retrieved access pattern in memory. For example, in the case where the function f_{t,m} is the function f_{t,1}, it is sufficient to save just the preceding retrieved position identifier, i.e. the indices xₜ₋₁ and yₜ₋₁ in memory.

As a variant, the original source code is not written in the V0 language, but, for example, in a conventional programming language like the C++ language or the C language. In this case, according to a first embodiment, the compiling module 64 is modified to execute, before operation 108, an operation of specializing the original source code provided. In this specializing operation, the compiling module 64 analyzes the source code and automatically introduces thereinto the specific instructions required for the implementation of the methods described here. For example, to this end, the compiling module 64 automatically replaces the instructions of the C++ language that deal with data structures with the corresponding specific instructions of the V0 language. In particular, the compiling module automatically replaces the portions of the original source code written in C++ language that access the data structures with the corresponding specific instructions of the V0 language. Subsequently, the remainder of the method for constructing the characteristic signature is identical to that which has been described above. According to a second embodiment, the module 64 is modified to directly transform the original source code written in a conventional language into an instrumented intermediate source code. For example, for this, the compiling module 64 analyzes the original source code to identify the portions of this original source code that deal with data structures. Next, each identified portion is automatically supplemented with the set of instrumentation instructions required to retrieve the access pattern for accessing these data structures. In this second embodiment, the V0 language is therefore not used. In another variant, the module 68 for retrieving the accesses is implemented in the form of a hardware module implemented, for example, in the microprocessor 56. In this case too, the executable code does not need to be instrumented to retrieve the access patterns. The hardware module for retrieving the accesses operates like in the case of the software implementation described above. In addition, preferably, in this case, each datum saved in the memory 58 comprises, in addition to the datum itself, the identifier of the data structure to which this datum belongs. Thus, the hardware module may easily retrieve the identifier of the data structure corresponding to the accessed datum. This variant is particularly advantageous in the case of the method for detecting an alteration to the executable code of a program. Specifically, in this case, the executable code of the program may be an executable code generated conventionally and therefore without any instruction for retrieving the access patterns. For example, the executable code is generated by compiling a source code in C++ or another language using a conventional compiler such as GDB. Such a compiler is accessible online at the following address; http://www.onlinegdb.com/. Such compilers generate an executable code which, when it is executed by a microprocessor, saves each datum in the memory with an identifier of the data structure to which this datum belongs.

As a variant, the retrieving module 68 is implemented so as to retrieve the access pattern only for a few of the data structures declared in the source code. For example, for this, just one or more of the data structures of the source code are accessed using the specific instructions of the V0 language. In this source code, the accesses to the other declared data structures for which no access pattern is to be retrieved are coded by directly using the corresponding instructions of the C++ language instead of using the specific instructions of the V0 language.

As a variant, the retrieving module 68 is modified to retrieve either only a read access pattern or only a write access pattern. A read access pattern is an access pattern that comprises only the position identifiers of the data of the data structure that are read during the execution of the executable code 76. Conversely, a write access pattern is an access pattern that comprises only the position identifiers of the data of the data structure that are written during the execution of the executable code 76. For example, to retrieve only the read access pattern, no specific instruction is used in the source code to code the write accesses to the data structure. For example, the instructions “MATRIX_SET” and “MATRIX_ADD” are replaced with conventional corresponding instructions of the C++ language in the source code 62.

During the same execution of the executable code 76, the module 68 may also retrieve, for the same data structure, a read access pattern and a write access pattern. For example, the specific write instructions are modified to save the position identifiers retrieved in an access pattern specific to writing while the specific read instructions are modified to save the position identifiers retrieved in an access pattern which are different and specific to reading. Next, these read and/or write access patterns are used as described above to obtain the signature characteristic of the accesses to this data structure. In this case, for example, the characteristic signature may comprise one statistical distribution constructed on the basis of the read access patterns and another statistical distribution constructed on the basis of the write access patterns.

In the case where the size of the data structures is not required in order to generate a model signature, the module 68 may be simplified so as not to retrieve this size.

As a variant, the retrieved position identifier is the virtual address of the accessed datum. In this case, the function f_{t,m} is adapted accordingly. For example, the function f_{t,1} is applied to the retrieved virtual address and no longer to each of the indices xₜ and yₜ. In other possible embodiments, the position identifier is neither an index nor the virtual address of the accessed datum. For example, the retrieved position identifier is the physical address of the datum in the main memory. This will be the case, for example, when no virtual memory mechanism is implemented.

In one simplified variant, step 126 of transforming the retrieved access pattern into a transformed access pattern is omitted. In this case, the statistical distribution is for example directly constructed on the basis of the retrieved access pattern. This variant is preferably combined with the case where the retrieved position identifier is an index used for identifying the position of the datum accessed inside the data structure.

In another simplified embodiment, the constructed statistical distribution is not normalized.

Section IV.3: Variants of the Compiler

When the hardware architecture of the compiler and of the target computing device are identical and no optimized arrangement for any of the data structures declared in the code could be identified, then the generation of the executable code 78 may be omitted. Specifically, in this particular case, the executable code 78 is identical to the executable code 76, such that it is not necessary to generate it again.

If the compiler 40 is only designed to generate executable code for a particular target computing device, the database 72 may be omitted and replaced simply with the function f_{t,m} to be implemented each time. In this case, the step of acquiring an identifier of the hardware architecture may also be omitted.

As a variant, the database 72 associates a plurality of functions f_{t,m} with the same hardware architecture identifier. In this case, on the basis of the same retrieved access pattern, the module 70 constructs a plurality of different signatures using each of the functions f_{t,m} that are associated with this architecture identifier. These different signatures are then compared with the model signatures. If just one of the constructed signatures corresponds to a model signature, then the optimized arrangement associated with this model signature is automatically selected. If a plurality of constructed signatures correspond to model signatures of the database 74, then just one of the optimized arrangements associated with these different model signatures is implemented. For example, in this case, the optimized arrangements are each associated with a priority index and it is the optimized arrangement associated with the highest priority index that is implemented.

Instead of containing parameterized signature models, the database 74 may directly contain the model signatures. In this case, typically, for one and the same particular traversal, the database comprises as many model signatures as there are possible sizes for the data structure. This increases the size of the database 74 but, in return, it simplifies the extraction of a model signature from this database. Specifically, it is then no longer necessary to generate this model signature on the basis of a parameterized signature model. In this case, it is also not necessary for the module 68 to retrieve the size of the data structure.

In the case of data structures other than two-dimensional matrices, signature models have to be established for each of these data structures. For this, the same methodology as that described in the case of two-dimensional matrices may be used.

The description above has been given in the particular case where the standard matrix arrangement implemented by the compiling module 64 is the row arrangement. As a variant, the standard arrangement may be different. For example, the standard arrangement may be considered to be the column or diagonal arrangement, or another arrangement.

The predefined performance to be improved of the target computing device may be different than the speed of execution of the computer program by this target computing device. For example, the predefined performance is chosen from the group consisting:

of the speed of execution of the executable code by the target computing device,

of the power consumed by the target computing device,

of the noise generated by the target computing device when it executes the executable code,

of the temperature of the target computing device,

of the mean time between failures.

In this case, each of the optimized arrangements saved in the database 74 is optimized to improve the predefined performance chosen from the group above.

In one more refined embodiment, in the case where the performance to be improved of the target computing device is not always the same, the database 74 comprises, associated with each signature model, an identifier of the performance to be improved and an arrangement optimized to improve this performance. Next, the module 70 acquires the identifier of the performance of the target computing device to be improved. Then, in operation 144, only the signature models associated with the same performance identifier as that acquired are used. Thus, in operation 146, only the arrangements optimized to improve this performance are selected.

In one simplified variant where the hardware architecture of the target computing device is always the same, the operation 118 of acquiring an identifier of the hardware architecture may be omitted. In addition, the database 72 is simplified since it may then just comprise only the transformation function associated with this target computing device.

In less refined embodiments, the comparison made during operation 144 is performed differently. For example, other coefficients of correlation may be used. For example, the coefficients of correlation known as “Kendall's tau rank” or “Spearman's rank” may be used.

As a variant, during the selection of the optimized arrangement for a data structure, the compiling module 66 presents the developer with a restricted list of optimized arrangements. This restricted list comprises only the optimized arrangements that are associated, by the database 74, with the signature models used to generate the model signatures that are most highly correlated with the signature constructed for this data structure. For example, the restricted list comprises only the optimized arrangements associated with the model signatures for which the calculated coefficient of correlation exceeds a predetermined threshold. Next, the developer selects, from this restricted list, the optimized arrangement to be used for this data structure. Here, what is meant by “restricted list of optimized arrangements” is a list that contains a number of optimized arrangements that may be used for this data structure which is smaller than the total number of optimized arrangements that are contained in the database 74 and may be used for this same data structure.

In the case where the original source code is not written in the V0 language but, for example, in a conventional programming language such as the C++ language or the C language, the compiling module 66 is modified in a similar manner to that which has been described, in the same case, for the compiling module 64. In particular, the module 66 is modified either to specialize the original source code by using for this purpose instructions of the V0 language or to directly transform the original source code into an optimized source code. For example, in this latter case, the compiling module 66 analyzes the original source code to identify the portions of this original source code that allocate memory space to a particular data structure. Next, the identified portion is automatically replaced with the optimized set of instructions that is selected on the basis of the signature of the accesses to this particular data structure.

Section IV.4: Variants of the Method for Detecting Alteration to the Executable Code

In one simplified embodiment, the signatures are constructed only for a portion of the data structures accessed by the microprocessor when it executes the executable code. In this case, the database may also be streamlined by comprising only the information required to extract model signatures just for this portion of the data structures. In one highly simplified version, said limited portion of the data structures comprises just one data structure.

If the size of the accessed data structures is always the same, the database BdRef directly contains the model signature associated with the identifier of this data structure. In this case, the signature models are not implemented.

As a variant, in phase 200, for each data structure, a specific signature model is constructed then saved in the database BdRef. The specific signature model makes it possible to extract a model signature that exhibits a coefficient of correlation higher than 0.8 or than 0.9 with the signature constructed for the same data structure in phase 202 in the absence of alteration to the executable code.

As a variant, the comparison of the time tₜ with the time t_{ref} in operation 210 is omitted. In this case, it is not necessary to save the time t_{ref} in the database BdRef.

Section V: Advantages of the Described Embodiments

Section V.1—Advantages of the Constructed Signature

The use of the set of the signatures characteristic of the accesses to the data structures as a signature characteristic of the accesses to the memory allows a more reproducible characteristic signature to be obtained. In particular, the characteristic signature thus constructed is more reproducible than a characteristic signature constructed by taking into account all of the accesses to the memory and without separating the accesses to a data structure from the other accesses to the memory.

In addition, the fact that the signature is constructed on the basis of relative position identifiers and not directly on the basis of the virtual or physical addresses makes it possible to obtain a signature that depends only on the way in which the data of the data structure are traversed during the execution of the computer program. Thus, the constructed signature is practically independent of the other characteristics of the executed computer program. For example, the constructed signatures obtained by executing two computer programs that are different but which access the data structure according to the same particular traversal are identical.

The use of relative position identifiers also makes the constructed signature insensitive to modification to the range of virtual or physical addresses that is allocated to this data structure. Specifically, it is common, in a subsequent execution of the same computer program, for the export system to allocate a different range of virtual or physical addresses to the same data structure.

By virtue of the fact that the statistical distribution is normalized, it matters little that one computer program reiterates the same processes on the data structure numerous times while another computer program executes these processes only once. If these two programs traverse the data structure in the same way, the signatures constructed for these two programs will be identical or very similar.

The fact that the relative position identifier is equal to the distance between two successively retrieved position identifiers makes it possible to obtain a transformed access pattern representative of the order in which the different data of the data structure are accessed.

The fact that the constructed signature comprises a statistical distribution for each index makes it possible to obtain a signature that is more distinctive than if the virtual addresses were used.

The construction of the signature characteristic of the accesses to the memory by using for this purpose not physical addresses but the indices or the virtual addresses of the accessed data makes it possible to obtain a signature that is independent:

of the operating system executed by the computing device that executes the computer program, and

of the arrangement of the data structure in the memory of the computing device.

The use of the transformation function f_{t,3} makes it possible to construct a characteristic signature that is particularly well suited to the case of hardware architecture comprising a secondary memory. In particular, this characteristic signature additionally makes it possible to identify the data of the data structure that it is preferable to save in the secondary memory.

Section V.2: Advantages of the Compiler

The described compiling method makes it possible to generate an optimized executable code that is functionally identical to that generated by conventional compilers, but which improves the performance of the target computing device that executes it. In particular, the improvement to the performance is obtained without modifying the algorithm of the computer program written by the developer.

Using the coefficient of correlation defined by relation (1) allows the compiling method to be made robust with respect to a substantial rate of random accesses to a data structure.

The fact that the optimized arrangement is an arrangement in which the data of the data structure are saved in the memory according to an order close to the temporal order in which they are accessed during the execution of the computer program substantially increases the speed of execution of the executable code on a target computing device comprising a cache memory.

The fact that the database 74 comprises at least the optimized arrangements of annexes 7 and 8 makes it possible to obtain an improvement to the speed of execution for the majority of source codes that contain matrix processing.

Saving parameterized signature models in the database 74 allows the size of this database to be decreased.

Section V.3—Advantages of Detecting Alteration to the Executable Code

The characteristic signature used to detect an alteration to the executable code is almost entirely insensitive to the context in which the computer program is executed. For example, the constructed signature is independent of the hardware architecture of the computing device on which the computer program is executed. It is also independent of accesses to the memory other than those implemented to access this data structure. By virtue of this insensitivity to the context of execution, the signature constructed during the execution of the computer program is highly reproducible. As such, the fact that the constructed signature is different from the model signature is a reliable indicator of an alteration to the executable code. Consequently, by virtue of this use of this constructed signature, it is not necessary, like in the article by Zhixing Xu cited above, to use a complicated mechanism to determine whether the constructed signature is or is not caused by a malicious alteration to the executable code.

Preferably, the steps of the method for detecting an alteration to the executable code are implemented for at least 25% or at least 50% of the data structures accessed by the microprocessor when it executes this executable code. The fact that signatures are constructed for a plurality of data structures of the executable code strengthens the reliability of the detecting method.

Comparing the times tₜ and t_{ref} additionally makes it possible to detect a modification to the flow of execution of the computer program when it is executed by a microprocessor.

### Annexes

Annex 1: Example of source code in V0 language

| | |
|---|---|
| 1 | #d e f i n e N0 10 |
| 2 | #d e f i n e N1 10 |
| 3 | #d e f i n e N2 10 |
| 4 | #d e f i n e TYPE i n t |
| 5 | |
| 6 | |
| 7 | v o i d m a t r i xMul t ( ) |
| 8 | { |
| 9 | MATRIX_DEFINE(TYPE, a ) ; |
| 10 | MATRIX_DEFINE(TYPE, b ) ; |
| 11 | MATRIX_DEFINE(TYPE, r e s ) ; |
| 12 | |
| 13 | MATRIX_ALLOCATE(TYPE, N0, N1 , a ) ; |
| 14 | |
| 15 | |
| 16 | |
| 17 | MATRIX_ALLOCATE(TYPE, N2 , N0 , b ) ; |
| 18 | |
| 19 | |
| 20 | |
| 21 | MATRIX_ALLOCATE(TYPE, N2 , N1 , r e s ) ; |
| 22 | |
| 23 | |
| 24 | |
| 25 | f o r (i n t j =0; j<N1 ; j++) |
| 26 | { |
| 27 | f o r (i n t i =0; i<N1 ; i++) |
| 28 | { |
| 29 | MATRIX_SET( r e s , i , j , 0) ; |
| 30 | f o r ( i n t k=0; k<N0 ; k++) |
| 31 | { |
| 32 | i n t tmp_a = MATRIX_GET( a , k , j ) : |
| 33 | i n t tmp_b = MATRIX_GET( b , i , k ) ; |
| 34 | MATRIX_ADD( r e s , i , j , tmp_a*tmp_b); |
| 35 | } |
| 36 | } |
| 37 | } |
| 38 | |
| 39 | MATRIX_FREE( a , N0 , N1 , TYPE) ; |
| 40 | |
| 41 | |
| 42 | MATRIX FREE( b , N2 , N0 , TYPE) ; |
| 43 | |
| 44 | |
| 45 | MATRIX_FREE( r e s , N2 , N1 , TYPE); |
| 45 | } |

Annex 2: Example of optimized intermediate source code in C++language

| | |
|---|---|
| 1 | #d e f i n e N0 10 |
| 2 | #d e f i n e N1 10 |
| 3 | #d e f i n e N2 10 |
| 4 | #d e f i n e TYPE i n t |
| 5 | |
| 6 | |
| 7 | v o i d m a t r i xMul t ( ) |
| 8 | { |
| 9 | i n t ** a ; |
| 10 | i n t **b ; |
| 11 | i n t ** r e s ; |
| 12 | |
| 13 | a = ( i n t **) ma l l o c (N1 * s i z e o f ( i n t *) ) ; |
| 14 | f o r ( i n t i =0; i <( i n t )N1 ; i++) |
| 15 | a [ i ] = ( i n t *) ma l l o c (N0* s i z e o f ( i n t ) ) ; |
| 16 | |
| 17 | b = ( i n t **) ma l l o c (N2 * s i z e o f ( i n t*) ) ; |
| 18 | f o r ( i n t i =0; i <( i n t )N2 ; i++) |
| 19 | b [ i ] = ( i n t *) ma l l o c (N0* s i z e o f ( i n t ) ) ; |
| 20 | |
| 21 | r e s = ( i n t **) ma l l o c (N1 * s i z e o f ( i n t *) ) ; |
| 22 | f o r ( i n t i =0; i <( i n t )N1 ; i++) |
| 23 | r e s [ i ] = ( i n t *) ma l l o c (N2* s i z e o f ( i n t ) ) ; |
| 24 | |
| 25 | f o r ( i n t j =0; j<N1 ; j++) |
| 26 | { |
| 27 | f o r ( i n t i =0; i<N2 ; i++) |
| 28 | { |
| 29 | r e s [ j ] [ i ] = 0 ; |
| 30 | f o r ( i n t k=0; k<N0 ; k++) |
| 31 | { |
| 32 | i n t tmp_a = a [ j ] [ k ] ; |
| 33 | i n t tmp_b = b [ i ] [ k ] ; |
| 34 | r e s [ j ] [ i ] += tmp_a*tmp_b ; |
| 35 | } |
| 36 | } |
| 37 | } |
| 38 | |
| 39 | f o r ( i n t i =0; i <( i n t )N0 ; i++) f r e e ( a [ i ] ) ; |
| 40 | f r e e ( a ) ; |
| 41 | |
| 42 | f o r ( i n t i =0; i <( i n t )N2 ; i++) f r e e ( b [ i ] ) ; |
| 43 | f r e e ( b ) ; |
| 44 | |
| 45 | f o r ( i n t i =0; i <( i n t )N2 ; i++) f r e e ( r e s [ i ] ) ; |
| 46 | f r e e ( r e s ) ; |
| 47 | |
| 48 | } |

### Annex 3: Signature Model of Traversal P1

### 1# Occurrence X

2 deltaX=[−dimX+1, 1]
3 occDeltaX=[dimY−1, dimY*(dimX−1)]
4

### 5 # Occurrence Y

6 deltaY=[0, 1]
7 occDeltaY=[dimY*(dimX−1), dimY−1]

### Annex 4: Signature Model of Traversal P2

### 1 # Occurrence X

2 deltaX=[0, 1]
3 occDel taX=[dimX*(dimY−1), dimX−1]
4

### 5 # Occurrence Y

6 occDeltaY=[−dimY+1, 1]
7 occDeltaY=[dimX−1, dimX*(dimY−1)]

### Annex 5: Signature Model of Traversal P3

1 diag=math.sqrt(dimX**2+dimY**2)
2 dim=min(dimX, dimY)
3 peack=dimX*dimY+1−(dimX+dimY)
4

### 5 # Occurrence X

6 deltaX=[i for i in range(−dim+2, 2)]
7 occDeltaX=[2 for i in range(−dim+2, 0)]
8 occDeltaX.append(peack)
9

### 10 # Occurrence Y

11 deltaY=[i for i in range (−dim+1, 2)]
12 occDeltaY=[2 for i in range(−dim+2, 0)]
13 occDeltaY.append (0)
14 occDeltaY.append (peack)
15
16 if (dimX<dimY):
17 occDeltaX.insert(0, dimY-dimX)
18 occDeltaY.insert(0, dimY-dimX)
19 else:
20 occDeltaX.insert(0, dimX−dimY+2)
21 occDeltaY.insert(0, dimX−dimY+2)

### Annex 6: Signature Model of Traversal P4

1 totalOcc=dimY*dimX−1
2

### 3 # Occurrence X

4 deltaX=[−dimX+1]
5 occDeltaX=[nbBlock_Y_cell−1]
6 totalOcc−=occDeltaX [−1]
7
8 occurrence1=(dimX−1)*nbBlock_Y_ceil
9 totalOcc−=occurrence1
10
11 deltaX.append (0)
12 occDeltaX.append (totalOcc)
13
14 deltaX.append(1)
15 occDeltaX.append(occurrence1)
16

### 17 # Occurrence Y

18 totalOcc=dimY*dimX−1
19

20 deltaY=[1−dimY_block]

21 occDeltaY=[(dimX−1)*nbBlock_Y]
22 totalOcc−=occDetaY[−1]
23
24 if (remainBlock_Y>0):
25 deltaY.append (1−remainBlock_Y)
26 occDeltaY.append (dimX−1)
27 totalOcc=occ=DeltaY [−1]
28
29 deltaY.append(1)
30 occDeltaY.append(totalOcc)

Annex 7: Optimized arrangement associated with the signature model of traversal P1

| | |
|---|---|
| Specific instructions in V0 | Generic code in C++ language |
| language | |
| MATRIX_DEFINE (TYPE, | TYPE **NAME; |
| NAME) | |
| MATRIX_ALLOCATE (TYPE, | NAME = (TYPE **) malloc (NBC * sizeof (TYPE*)): |
| NBL, NBC, NAME) | for (int i = 0; i <(int) NBC i++) |
| | NAME [i] = (TYPE *) malloc (NBL *sizeof (TYPE)); |
| MATRIX_GET (NAME, NDL, | NAME [NDL] [NDC]; |
| NDC) | |
| MATRIX_SET (NAME, NDL | NAME [NDL] [NDC] = VALUE; |
| NDC, VALUE) | |
| MATRIX_FREE (NAME, NBL, | for (int i = 0; i <(int) NBL i++) free (NAME [i]); |
| NBC, TYPE) | free (NAME); |

Annex 8: Optimized arrangement associated with the signature model of traversal P2

| | |
|---|---|
| Specific instructions in V0 | Generic code in C++ language |
| language | |
| MATRIX_DEFINE (TYPE, | TYPE **NAME; |
| NAME) | |
| MATRIX_ALLOCATE (TYPE, | NAME = (TYPE **) malloc (NBL * sizeof (TYPE*)): |
| NBL, NBC, NAME) | for (int i = 0; i <(int) NBL i++) |
| | NAME [i] = (TYPE *) malloc (NBC *sizeof (TYPE)); |
| MATRIX_GET (NAME, NDL, | NAME [NDL] [NDC]; |
| NDC) | |
| MATRIX_SET (NAME, NDL, | NAME [NDL] [NDC] = VALUE; |
| NDC, VALUE) | |
| MATRIX_FREE (NAME, NBL, | for (int i = 0; i <(int) NBL i++) free (NAME [i]); |
| NBC, TYPE) | free (NAME); |

Annex 9: Optimized arrangement associated with the signature model of tr versal P3

| | |
|---|---|
| Specific instructions in V0 | Generic code in C++ language |
| language | |
| MATRIX_DEFINE (TYPE, | TYPE **NAME; |
| NAME) | |
| MATRIX_ALLOCATE (TYPE, | NAME = (TYPE **) malloc ((NBL + NBC +1) * |
| NBL, NBC, NAME) | sizeof (TYPE)); |
| | for (int i = 0; i <(int) (NBL + NBC +1); i++) |
| | {NAME [i] = (TYPE *) malloc ((NBL + NBC +1) * |
| | sizeof (TYPE))}; |
| MATRIX_GET (NAME, NDL, | NAME [NDL] [NDC]; |
| NDC) | |
| MATRIX_SET (NAME, NDL, | NAME [NDL] [NDC] = VALUE; |
| NDC, VALUE) | |
| MATRIX_FREE (NAME, NBL, | for (int i = 0; i <(int) NBL i++) free (NAME [i]); |
| NBC, TYPE) | free (NAME); |

1. A method for constructing a signature characteristic of the accesses, by a microprocessor, to a memory when this microprocessor executes a computer program, this method comprising, to this end, the execution of the computer program by the microprocessor and, during this execution, the microprocessor reiterates the following operations multiple times:
1) the microprocessor constructs the address of a datum to be accessed inside a data structure on the basis of an identifier of the data structure and on the basis of the value of one or more indices that are used to identify the position of the datum to be accessed inside the data structure, then
2) the microprocessor executes an access instruction for accessing this datum of the data structure, this access instruction being parameterized by the constructed address, then
3) the microprocessor executes an instruction that modifies the value of at least one of these indices so as to access the following datum of the data structure in the next iteration of operations 1) and 2),
wherein the method comprises the following steps:
4) each time operation 2) is executed, the microprocessor retrieves the identifier of the data structure and a position identifier that identifies the position of the datum accessed inside this data structure, this position identifier being chosen from the group consisting:
of the indices that allow the position of the datum inside the data structure to be identified, and
of the virtual address of the datum accessed when the data structure is located within a single continuous range of virtual addresses in which there are no data which belong to this data structure,
the temporally ordered series of the position identifiers thus retrieved forming a retrieved access pattern, then
5) for each retrieved access pattern associated with one and the same data structure identifier, the microprocessor constructs a statistical distribution on the basis of just the position identifiers of this retrieved access pattern, this statistical distribution being independent of the access instructions executed to access this data structure,
the set of the statistical distributions thus constructed and associated with the identifier of this data structure forming a signature characteristic of the accesses to this data structure and the set of the signatures characteristic of the accesses to the data structures forming the signature characteristic of the accesses, by the microprocessor, to the memory.

2. The method as claimed in claim 1, wherein, in step 5):
the microprocessor transforms the retrieved access pattern into a transformed access pattern by applying a transformation function that replaces each retrieved position identifier with a relative position identifier in relation to another datum of the same data structure, the transformation function being suitable, in addition, for generating a transformed access pattern allowing the construction of a characteristic signature suitable for identifying one particular traversal of the data of the data structure from among a plurality of possible traversals, then
for each transformed access pattern associated with one and the same data structure identifier, the microprocessor constructs a statistical distribution of the relative position identifiers of this transformed access pattern, this statistical distribution comprising:
a classes of possible values for the relative position identifiers, and associated with each of these classes,
a number dependent on the number of occurrences of this class in the transformed access pattern.

3. The method as claimed in claim 2, wherein the application of the transformation function replaces each retrieved position identifier with the distance between this retrieved position identifier and the previously retrieved position identifier.

4. The method as claimed in claim 1, wherein each statistical distribution is a normalized statistical distribution in which the total of the numbers associated with each class of the statistical distribution is equal to one.

5. The method as claimed in claim 1, wherein, in step 4), the microprocessor retrieves the values of each index used to construct the address of the accessed datum and treats each retrieved index as a position identifier, such that, in step 5), the constructed characteristic signature comprises a normalized statistical distribution for each of these indices.

6. The method as claimed in claim 5, wherein the data structure is a matrix and the indices correspond to the numbers of rows and of columns at the intersection of which is located the datum to be accessed inside this matrix.

7. The method as claimed in claim 1, wherein:
the microprocessor transforms the retrieved access pattern into a transformed access pattern by applying a transformation function that replaces each retrieved position identifier with a value f_{t,3}(D_{S,n}) proportional to a ratio Av(D_{S,n})/Occ(D_{S,n}), where:
D_{S,n} is the datum whose position identifier has been retrieved,
Occ(D_{S,n}) is a quantity representative of the number of occurrences of the datum D_{S,n} in the retrieved access pattern,
Av(D_{S,n}) is the average number of accesses to other data of the data structure between two consecutive accesses to the datum D_{S,n},
the transformed access pattern thus obtained allowing the construction of a characteristic signature suitable for identifying one particular traversal of the data of the data structure from among a plurality of possible traversals, then
for each transformed access pattern associated with one and the same data structure identifier, the microprocessor constructs the statistical distribution on the basis of the values f_{t,3}(D_{S,n}) contained in this transformed access pattern.

8. A method for compiling a source code of a computer program for a target computing device, this method comprising:
a) the provision of the source code of the computer program, this source code containing:
a declaration of a data structure, this data structure being suitable for being saved in a memory of the target computing device according to a standard arrangement and, alternately, according to an optimized arrangement, the optimized arrangement corresponding to an arrangement of the data of the data structure in the memory which improves a performance of the target computing device when the target computing device traverses the data of this data structure in a particular order, the standard arrangement corresponding to an arrangement of the data of the data structures in the memory which does not improve the performance of the target computing device as much when the target computing device traverses the data of the data structure in the same particular order, and
instructions for accessing the data of the data structure,
b) the provision of a database from which a model signature of the accesses to this data structure may be extracted, this model signature being identical to that obtained by implementing the method of claim 1 for constructing the signature characteristic of the accesses to this data structure, when the microprocessor executes a computer program which traverses the data of this data structure in said particular order,
c) the generation, on the basis of the source code and by a compiler, of a first executable code of the computer program, and
d) the execution, by the compiler, of this first executable code,
wherein the method also comprises the execution, by the compiler, of the following steps:
e) the construction, by the compiler, of a signature characteristic of the accesses to the data structure by implementing the method of claim 1, then
f) the comparison of the constructed signature with the model signature extracted from the database, then
g) only when the model signature corresponds to the constructed signature, the generation, on the basis of the same source code, of a second executable code of the computer program suitable for being executed by the target computing device and which, when it is executed by the target computing device, uses the optimized arrangement to save the data structure in the memory of the target computing device.

9. The method as claimed in claim 8, wherein:
step b) comprises the provision of a database that allows each extracted model signature to be associated with at least one target computing device hardware architecture identifier,
the method comprises a step of acquiring an identifier of the hardware architecture of the target computing device, and
in step f), the model signature corresponds to the constructed signature only if the model signature is also associated with a hardware architecture identifier that is identical to the acquired hardware architecture identifier.

10. The method as claimed in claim 8, wherein
step f) comprises the calculation of a coefficient ρ(DS_{c}, DSₘ) of correlation between a statistical distribution of the model signature and a statistical distribution of the constructed signature according to the following relationship:
$$ρ ( {DS}_{c} , {DS}_{m} ) = \frac{1}{N} \frac{{\sum }_{i = 0}^{N - 1} ( {DS}_{c} [ i ] - {E}_{DSc} ) ( {DS}_{m} [ i ] - {E}_{DSm} )}{{σ}_{s} {σ}_{{s}^{′}}}$$
where:
DS_{c} and DSₘ are, respectively, the compared statistical distribution of the constructed signature and statistical distribution of the model signature,
ρ(DS_{c}, DSₘ) is the calculated coefficient of correlation,
N is the total number of classes of the compared statistical distributions,
DS_{c}[i] is the quantity associated with the i^{th} class by the statistical distribution DS_{c},
DSₘ[i] is the quantity associated with the i^{th} class by the statistical distribution DSₘ,
E_{DSc} and E_{DSm} are the expected values, respectively, of the statistical distributions DS_{c} and DSₘ,
σ_{DSc} and σ_{DSm} are the standard deviations, respectively, of the statistical distributions DS_{c} and DSₘ, and
the model signature corresponds to the constructed signature only if the calculated coefficient ρ(DS_{c}, DSₘ) is the largest of the coefficients calculated in step f) or exceeds a predetermined threshold.

11. The method as claimed in claim 8, wherein:
the memory of the target computing device comprises a cache memory and the performance improved by the optimized arrangement is the speed of execution,
the characteristic signature is a characteristic signature representative of the particular order in which the microprocessor traverses the data of the data structure when it executes the computer program, and
the optimized arrangement is an arrangement in which the data of the data structure are saved in memory, one immediately after the other, in an order closer to the temporal order in which they are accessed during the execution of the computer program than the order in which they are saved in memory when the standard arrangement is used.

12. The method as claimed in claim 8, in which, in steps c) and g), the order of execution of the instructions for accessing the data of the data structure of the source code is left unchanged.

13. The method as claimed in claim 8, wherein:
the provision of the database comprises the provision of a database containing a signature model parameterized by the size of the data structure, this signature model allowing the generation, for said particular traversal, of the different model signatures which correspond to each of the possible sizes of the data structure,
during the execution, by the compiler, of the first executable code, the compiler retrieves the size of the data structure, and
before step f), the compiler constructs the model signature with which the constructed signature is compared using the signature model saved in the database and the retrieved size of the data structure.

14. The method as claimed in claim 13, wherein the declared data structure is a two-dimensional matrix and the provided database contains:
a first signature model parameterized by the size of the matrix for a first particular traversal in which the data of the matrix are traversed row by row, and
a second signature model parameterized by the size of the matrix for a second particular traversal in which the data of the matrix are traversed column by column.

15. A method for detecting an alteration to an executable code of a computer program executed by a microprocessor, this microprocessor repeatedly accessing data of a data structure saved in a memory when it executes this executable code, this method comprising:
a) the provision of a database from which a model signature of the accesses to this data structure may be extracted, this model signature being identical to that obtained by implementing the method of claim 1 for constructing a characteristic signature when the microprocessor executes said executable code in the absence of any alteration, then
b) the execution of the executable code of the computer program by the microprocessor, and
c) during this execution of the executable code, the construction of what is referred to as a “constructed” signature of the accesses to this data structure by implementing the method of claim 1 for constructing this characteristic signature, then
d) the comparison of the constructed signature with the model signature extracted from the database, then
e) when the constructed signature is different from the model signature, the triggering of the signaling of an alteration to the executable code, and
f) when the constructed signature corresponds to the model signature, the absence of this triggering of the signaling of an alteration to the executable code.

16. The method as claimed in claim 15, wherein:
in step a), the provided database also associates a time t_{ref} with each model signature which may be extracted, the time t_{ref} being equal to the time at which the data structure is accessed by the microprocessor when it executes the executable code in the absence of alteration,
in step b), a time tₜ at which the data structure is accessed is retrieved by the microprocessor, and
in step d), when the deviation between the times tₜ and t_{ref} associated with the same data structure identifier is greater than a predetermined threshold, the compared signatures are considered to be different.

17. A non-transitory computer-readable storage medium, readable by a microprocessor, wherein this medium comprises instructions for executing a method according to claim 1.

18. A compiler of a source code of a computer program, this compiler being configured to:
a) acquire the source code of the computer program, this source code containing:
a declaration of a data structure, this data structure being suitable for being saved in a memory of the target computing device according to a standard arrangement and, alternately, according to an optimized arrangement, the optimized arrangement corresponding to an arrangement of the data of the data structure in the memory which improves a performance of the target computing device when the target computing device traverses the data of this data structure in a particular order, the standard arrangement corresponding to an arrangement of the data of the data structures in the memory which does not improve the performance of the target computing device as much when the target computing device traverses the data of the data structure in the same particular order, and
instructions for accessing the data of the data structure,
b) save a database from which a model signature of the accesses to this data structure may be extracted, this model signature being identical to that obtained by implementing the method as claimed in claim 1 for constructing the signature characteristic of the accesses to this data structure, when the microprocessor executes a computer program which traverses the data of the data structure in said particular order,
c) automatically generate, on the basis of the source code, a first executable code of the computer program, and
d) execute this first executable code,
wherein the compiler is also configured to execute the following steps:
e) constructing a signature characteristic of the accesses to the data structure by implementing the method as claimed in claim 1, then
f) comparing the constructed signature with the model signature extracted from the database, then
g) only when the model signature corresponds to the constructed signature, generating, on the basis of the same source code, a second executable code of the computer program suitable for being executed by the target computing device and which, when it is executed by the target computing device, uses the optimized arrangement to save the data structure in the memory of the target computing device.
